(19) United States
(12) Patent Application Publication
(10) Pub. No.: US 2024/0043694 A1
(43) Pub. Date: Feb. 8, 2024

(54) HIGH PHASE-PURITY GROWTH OF 1T'-TRANSITION METAL DICHALCOGENIDE MONOLAYERS

(71) Applicant: City University of Hong Kong, Hong Kong (HK)

(72) Inventors: Hua ZHANG, Hong Kong (HK); Zijian LI, Hong Kong (HK); Li ZHAI, Hong Kong (HK)

(21) Appl. No.: 18/358,899

(22) Filed: Jul. 25, 2023

Related U.S. Application Data
(60) Provisional application No. 63/392,490, filed on Jul. 26, 2022.

(51) Int. Cl. C09C 1/62; C09C 3/06

(52) U.S. Cl. CPC C09C 1/62; C09C 3/063; C01P 2004/80; C01P 2004/16; C01P 2004/04; C01P 2002/85; C01P 2002/82; C01P 2004/03; C01P 2002/72; G01N 21/658

(57) ABSTRACT

A method of forming a 1T′-phase transition metal dichalcogenide monolayer. A transition metal precursor and a first solvent are mixed to form a first mixture. A non-oxygen chalcogen or non-oxygen chalcogen precursor and a second solvent are mixed to form a second mixture. The first mixture is rapidly injected into the second mixture at a temperature between approximately 250 and 350° C. to form a third mixture. 1T′-transition metal dichalcogenide monolayers are recovered from the third mixture. The transition metals may be molybdenum or tungsten, while the non-oxygen chalcogens may be sulfur, selenium, or tellurium. The 1T′-transition metal dichalcogenide monolayers can be grown on a variety of metal substrates to form metal@ 1T′-transition metal dichalcogenide monolayer heterostructures. A flexible 4H-Au@1T′-WS₂/SiO₂/PDMS SERS tape was fabricated to detect the SARS-CoV-2 spike protein. The tape is capable of attomole-level detection of SARS-CoV-2 spike protein, for real-time monitoring of COVID-19.

### CROSS-REFERENCE TO RELATED APPLICATIONS

The present application claims priority under 35 U.S.C. 119(e) to U.S. Provisional Patent Application 63/392,490 filed 26 Jul. 2022, the disclosure of which is incorporated by reference herein.

### FIELD OF THE INVENTION

The present invention relates to synthesis of 1T′-transition metal dichalcogenide monolayers through a low temperature, rapid, wet-chemical technique.

### BACKGROUND

Atomically thin transition metal dichalcogenides (TMDs) have attracted tremendous interest owing to their unique physicochemical properties and a broad range of applications in various fields, including catalysis, sensing, electronics, energy conversion, and energy, and biomedicine. As an emerging strategy, phase engineering of nanomaterials (PEN) enables the rational design and synthesis of nanomaterials with unconventional crystal phases, which is of great significance for realizing tunable physicochemical properties and enhanced performances in various applications. For example, the most investigated group VI-B TMDs, e.g., MoS₂, WS₂, MoSe₂, and WSe₂, mainly exist as the thermodynamically stable 2H phase with the semiconducting property as well as the metastable 1T and 1T′ phases with metallic and semi-metallic properties, respectively. Importantly, owing to the unique crystal structures of 1T′-TMDs, 1T′-TMDs with appealing physicochemical properties exhibit superior performance compared to 2H-TMDs in a variety of applications, including electrocatalysis, superconductivity, and surface-enhanced Raman scattering (SERS). A few synthesis strategies have been reported to prepare 1T′-TMDs, such as thermal annealing method, chemical vapor deposition (CVD), chemical/electrochemical alkali metal ions intercalation method, hydrothermal method, and colloidal method. However, due to the high formation energy of 1T′-TMDs and the strong van der Waals (vdW) force between the layers of 1T′-TMDs, the direct synthesis of single-layer, high-quality 1T′-TMDs remains challenging.

Recently, substrate engineering has been considered an effective strategy to prepare single-layer TMDs and regulate the phases of TMDs. As a typical example, metallic substrates (e.g., Au, Ag, and Cu) play significant roles in the 2H-1T′ phase transition of the single-layer TMDs due to the strong interfacial interaction between TMD monolayers and metallic substrates. A high-temperature annealing method has been used to synthesize single-layer MoS₂ with a 1T′ phase purity of ˜37% on Au substrate. A 2H-1T′ phase transition has been achieved due to the electron doping from the Au substrate as well as the interfacial tensile strain. The phase purity of the 1T′ phase in TMD monolayers can be further increased through the enhancement of interfacial interaction, i.e., larger charge transfer, increased interfacial binding energy, and shorter interfacial spacing. However, the aforementioned TMD monolayers on the surface of the metallic surfaces still suffer from impure products, such as 2H-TMDs and oxides. In addition, owing to the metastable nature of the 1T′-TMDs, the 1T′ phase part in the TMD monolayers will gradually covert back to the thermodynamically stable 2H phase during the disturbance of ambient conditions.

Therefore, there is a need to develop facile and robust methods for the controlled synthesis of crystal phase-stable and high-phase-purity 1T′-TMD monolayers, particularly, phase-stable and high-phase-purity 1T′-TMD monolayers. The present invention addresses this need.

### SUMMARY OF THE INVENTION

In one aspect, the present invention provides a method of synthesizing 1T′-phase transition metal dichalcogenide monolayer. A transition metal precursor and a first solvent are mixed to form a first mixture. A non-oxygen chalcogen or non-oxygen chalcogen precursor and a second solvent are mixed to form a second mixture. The first mixture is rapidly injected into the second mixture at a temperature between approximately 250 and 350° C. to form a third mixture. 1T′-transition metal dichalcogenide monolayers are recovered from the third mixture.

In a further aspect, the first solvent is oleylamine.

In a further aspect, the second mixture further comprises octadecylamine, oleylamine, and octadecene.

In a further aspect, a transition metal of the transition metal precursor is one or more of tungsten or molybdenum.

In a further aspect, the transition metal precursor is one or more of ammonium tungsten oxide or ammonium molybdate, tungsten chloride or molybdenum chloride.

In a further aspect, the non-oxygen chalcogen is one or more of sulfur, selenium, or tellurium.

In a further aspect, the 1T′-transition metal dichalcogenide monolayers are MoS₂, WS₂, MoSe₂, WSe₂, or MoTe₂ monolayers.

In a further aspect, the 1T′-transition metal dichalcogenide monolayers are formed on metal substrates. The metal substrates may be gold nanoparticles.

In particular, the gold nanoparticles may be gold nanowires, such as 4H phase gold nanowires.

The recovering from the third mixture may be performed by centrifugation.

The 1T′-transition metal dichalcogenide monolayers may be deposited on a polymer substrate having a hard transparent coating formed thereon to create a substrate for surface-enhanced Raman spectroscopy (SERS).

### BRIEF DESCRIPTION OF THE DRAWINGS

FIG. 1 shows a schematic illustration of the general strategy for the wet-chemical synthesis of four kinds of single-layer 1T′-TMDs, including 1T′-WS₂, WSe₂, MoS₂, and MoSe₂, on 4H—Au NWs to form 4H—Au@1T′-TMDs.

FIG. 2a shows the STEM image of a 4H—Au@1T′-WS₂.

FIG. 2b shows the HAADF-STEM image of a single segment of a 4H—Au@1T′-WS₂.

FIG. 2c shows the corresponding FFT pattern.

FIG. 2d shows the STEM image and the corresponding EDS elemental mapping of a single segment of a 4H—Au@1T′-WS₂.

FIG. 2e shows the atomic-resolution HAADF-STEM image at the interface of 1T′-WS₂ monolayer and 4H—Au.

FIG. 2f shows the corresponding integrated pixel intensity profiles of 1T′-WS₂ (red area) and 4H—Au (blue area) in FIG. 2e, respectively.

FIG. 3a shows the high-resolution XPS spectra of W 4f of the as-prepared 4H—Au@1T′-WS₂, freestanding WS₂ monolayer, and commercial 2H—WS₂.

FIG. 3b shows the Raman spectra of the as-prepared 4H—Au@1T′-WS₂, freestanding WS₂ monolayer, and commercial 2H—WS₂.

FIG. 3c shows the normalized W L₃-edge XANES spectra of the as-prepared 4H—Au@1T′-WS₂, freestanding WS₂ monolayer, and commercial 2H—WS₂. Inset in FIG. 3c: enlarged normalized W L₃-edge XANES spectra from 10205 to 10209 eV.

FIG. 3d shows the Fourier transform of W L₃-edge EXAFS spectra of the as-prepared 4H—Au@1T′-WS₂, freestanding WS₂ monolayer, and commercial 2H—WS₂. Inset in FIG. 3d: enlarged W L₃-edge EXAFS spectra from 2 to 4 Å in R space.

FIG. 4a shows the ABF-STEM image and the corresponding schematic illustration of the growth process of 1T′-WS₂ monolayer on 4H—Au extracted at ˜30 s.

FIG. 4b shows the ABF-STEM image and the corresponding schematic illustration of the growth process of 1T′-WS₂ monolayer on 4H—Au extracted at ˜60 s.

FIG. 4c shows the ABF-STEM image and the corresponding schematic illustration of the growth process of 1T′-WS₂ monolayer on 4H—Au extracted at ˜90 s.

FIG. 4d shows the atomic-resolution ABF-STEM image and simulated model of the interface between 1T′-WS₂ monolayer and 4H—Au.

FIG. 4e shows the normalized S K-edge XANES spectra of the as-prepared 4H—Au@1T′-WS₂, 1T′-WS₂ crystal, and 2H—WS₂ crystal.

FIG. 4f shows the high-resolution XPS Au 4f spectra of the as-prepared 4H—Au@1T′-WS₂ and 4H—Au.

FIG. 4g shows the Fourier transform of Au L₃-edge EXAFS spectra of the as-prepared 4H—Au@1T′-WS₂ and 4H—Au.

FIG. 5a shows the schematic illustration of a single 4H—Au@ 1T′-TMD as SERS platform for Raman enhancing of dye molecules.

FIG. 5b shows the Raman spectra of R6G coated on a single 4H—Au@1T′-WS₂, 4H—Au@ 1T′-WSe₂, 4H—Au@ 1T′-MoS₂, and 4H—Au@ 1T′-MoSe₂ with a fixed concentration of 10⁻⁹ M.

FIG. 5c shows the optical microscope image of a single 4H—Au@ 1T′-WS₂ used for SERS detection.

FIG. 5d shows the SEM image of the 4H—Au@1T′-WS₂ in FIG. 5c.

FIG. 5e shows the SERS spectra of R6G (10⁻⁹ M) at three different positions on the same 4H—Au@ 1T′-WS₂ in FIG. 5c.

FIG. 5f shows the Raman spectra of R6G coated on the 4H—Au@ 1T′-WS₂, 4H—Au, 1T′-WS₂ monolayer, 2H/1T′-WS₂ monolayer, 2H—WS₂ monolayer, and bare SiO₂ substrate with a fixed concentration of 10⁻⁹ M.

FIG. 5g shows the Raman spectra of R6G coated on a single 4H—Au@1T′-WS₂ with various concentrations from 10⁻¹² M (pM) to 10⁻¹⁸ M (aM).

FIG. 5h shows the calculated Raman EF from the peak intensity (1360 cm⁻¹) of R6G at different concentrations in FIG. 5g.

FIG. 6a shows the schematic illustration of the flexible 4H—Au@ 1T′-WS₂/SiO₂/PDMS tape for the Raman scattering of SARS-CoV-2 S protein under the excitation laser of 633 nm.

FIG. 6b shows the Image of the flexible 4H—Au@ 1T′-WS₂/SiO₂/PDMS tape during the SERS detection of SARS-CoV-2 S protein.

FIG. 6c shows the Raman spectra of 10⁻⁹ M (nM) SARS-CoV-2 S protein (Omicron/B.1.1.529 variant) on the 4H—Au@1T′-WS₂ and bare SiO₂ on the PDMS tape.

FIG. 6d shows the Raman spectra of SARS-CoV-2 S protein (Omicron/B.1.1.529 variant) coated on the 4H—Au@ 1T′-WS₂ with various concentrations from 10⁻⁹ M (nM) to 10⁻¹⁸ M (aM).

FIG. 6e shows the Raman spectra of the subtype of SARS-CoV-2 S protein (Wild Type and Omicron/B.1.1.529 variant) with a fixed concentration of 10⁻¹⁵ M (fM).

FIG. 7a shows the low-magnification SEM image of 4H—Au.

FIG. 7b shows the statistic histograms showing the length of 4H—Au in FIG. 7a.

FIG. 7c shows the low-magnification TEM image of 4H—Au.

FIG. 7d shows the HAADF-STEM image of a typical 4H—Au.

FIG. 7e shows the corresponding FFT pattern of a typical 4H—Au.

FIG. 7f shows the atomic-resolution HAADF-STEM image of a typical 4H—Au, indicating the atomic stacking sequence of 4H phase, that is, ABCB stacking.

FIG. 8 shows the XRD pattern of 4H—Au.

FIG. 9a shows the XANES spectra at the Au L₃-edge of 4H—Au, fcc-Au, and HAuCl₄.

FIG. 9b shows the Fourier transform of Au L₃ EXAFS spectra of 4H—Au, fcc-Au, and HAuCl₄.

FIG. 10a shows the low-magnification SEM image of 4H—Au@1T′-WS₂.

FIG. 10b shows the statistic histograms showing the length of 4H—Au@1T′-WS₂ in FIG. 10a.

FIG. 11a shows the low-magnification TEM image of 4H—Au@1T′-WS₂

FIG. 11b shows the TEM image of a typical 4H—Au@1T′-WS₂.

FIG. 12 shows the XRD pattern of 4H—Au@1T′-WS₂.

FIG. 13a shows the STEM image of a single segment of a 4H—Au@1T′-WS₂.

FIG. 13b shows the corresponding STEM-EDS elemental line scan along the pink dashed line in FIG. 13a.

FIG. 14a shows the HAADF-STEM image of a single segment of a 4H—Au@1T′-WS₂.

FIG. 14b shows the Intensity profile along the red line in FIG. 14a, confirming the 1T′-WS₂ monolayer.

FIG. 15a shows the ABF-STEM image of a single segment of a 4H—Au@1T′-WS₂.

FIG. 15b shows the intensity profile along the red line in FIG. 15a, confirming the 1T′-WS₂ monolayer.

FIG. 16 shows the atomic structure models of 1T′-TMDs viewed from top and side, respectively.

FIG. 17a shows the TEM image of the synthesized freestanding WS₂ monolayers in the absence of 4H—Au substrates.

FIG. 17b shows the HRTEM image of the as-synthesized freestanding WS₂ monolayers with 1T′ phase.

FIG. 17c shows the corresponding FFT pattern of the as-synthesized freestanding WS₂ monolayers with 1T′ phase.

FIG. 17d shows the HRTEM image of the as-synthesized freestanding WS₂ monolayers with the 2H phase.

FIG. 17e shows the corresponding FFT pattern of the as-synthesized freestanding WS₂ monolayers with the 2H phase.

FIG. 18 shows the k²-weighted EXAFS oscillations of the as-prepared 4H—Au@1T′-WS₂, freestanding WS₂ monolayer, and commercial 2H—WS₂.

FIG. 19a shows the low-magnification SEM image of 4H—Au@1T′-WSe₂.

FIG. 19b shows the statistic histograms showing the length of 4H—Au@1T′-WSe₂ in FIG. 19a.

FIG. 20a shows the low-magnification TEM image of 4H—Au@1T′-WSe₂.

FIG. 20b shows the TEM image of a typical 4H—Au@1T′-WSe₂.

FIG. 21a shows the STEM image of a single segment of a 4H—Au@1T′-WSe₂.

FIG. 21b shows the HAADF-STEM images of the end part of a 4H—Au@1T′-WSe₂ in FIG. 21a.

FIG. 21c shows the HAADF-STEM image of the side part of a 4H—Au@1T′-WSe₂ in FIG. 21a.

FIG. 21d shows the corresponding FFT patterns recorded from the pink dashed area in FIG. 21b.

FIG. 21e shows the corresponding FFT patterns recorded from the pink dashed area in FIG. 21c.

FIG. 21f shows the atomic-resolution HAADF-STEM image of a single segment of a 4H—Au@1T′-WSe₂.

FIG. 21g shows the intensity profile along the red line in FIG. 21f, confirming the 1T′-WSe₂ monolayer.

FIG. 22a shows the HAADF-STEM image of a single segment of a 4H—Au@1T′-WS3₂.

FIG. 22b shows the Intensity profile along the red line in FIG. 22a, confirming the 1T′-WSe₂ monolayer.

FIG. 22c shows the ABF-STEM image of a single segment of a 4H—Au@1T′-WSe₂.

FIG. 22d shows the intensity profile along the red line in FIG. 22c, confirming the 1T′-WSe₂ monolayer.

FIG. 23a shows the STEM image of a single segment of a 4H—Au@1T′-WSe₂.

FIG. 23b shows the corresponding STEM-EDS elemental line scan along the pink dashed line in FIG. 23a.

FIG. 23c shows the corresponding EDS elemental mapping of a single segment of a 4H—Au@1T′-WSe₂, indicating the uniform growth of WSe₂ on the surface of 4H—Au.

FIG. 24 shows the XPS spectra of 4H—Au@1T′-WSe₂, freestanding WSe₂ monolayer, and commercial 2H—WSe₂.

FIG. 25 shows the Raman spectra of 4H—Au@1T′-WSe₂, freestanding WSe₂ monolayer, and commercial 2H—WSe₂.

FIG. 26a shows the TEM image of the synthesized freestanding WSe₂ monolayers in the absence of 4H—Au substrates.

FIG. 26b shows the HRTEM image of the as-synthesized freestanding WSe₂ monolayers with 1T′ phase.

FIG. 26c shows the corresponding FFT pattern of the as-synthesized freestanding WSe₂ monolayers with 1T′ phase.

FIG. 26d shows the HRTEM image of the as-synthesized freestanding WSe₂ monolayers with the 2H phase.

FIG. 26e shows the corresponding FFT pattern of the as-synthesized freestanding WSe₂ monolayers with the 2H phase.

FIG. 27a shows the low-magnification SEM image of 4H—Au@1T′-MoS₂.

FIG. 27b shows the statistic histograms showing the length of 4H—Au@1T′-MoS₂ in FIG. 27a.

FIG. 28a shows the low-magnification TEM image of 4H—Au@1T′-MoS₂.

FIG. 28b shows the TEM image of a typical 4H—Au@1T′-MoS₂.

FIG. 29a shows the STEM image of a 4H—Au@1T′-MoS₂.

FIG. 29b shows the HAADF-STEM image of a single segment of a 4H—Au@1T′-MoS₂ recorded from the blue area in FIG. 29a.

FIG. 29c shows the corresponding FFT pattern recorded from the pink dashed area in FIG. 29b.

FIG. 29d shows the atomic-resolution HAADF-STEM image recorded from the blue area in FIG. 29b.

FIG. 29e shows the intensity profile along the red line in FIG. 29d, confirming the 1T′-MoS₂ monolayer.

FIG. 29f shows the atomic-resolution HAADF-STEM image recorded from the blue area in FIG. 29b, indicating a regular growth relationship between 4H—Au and 1T′-MoS₂ monolayer.

FIG. 30a shows the STEM image of a single segment of a 4H—Au@1T′-MoS₂.

FIG. 30b shows the corresponding EDS elemental line scan along the pink dashed line in FIG. 30a.

FIG. 30c shows the corresponding EDS elemental mapping of a single segment of a 4H—Au@1T′-MoS₂, indicating the uniform growth of MoS₂ on the surface of 4H—Au.

FIG. 31a shows the TEM image of the synthesized freestanding MoS₂ monolayers in the absence of 4H—Au substrates.

FIG. 31b shows the HRTEM image of the as-synthesized freestanding MoS₂ monolayers with 1T′ phase.

FIG. 31c shows the corresponding FFT pattern of the as-synthesized freestanding MoS₂ monolayers with 1T′ phase.

FIG. 31d shows the HRTEM image of the as-synthesized freestanding MoS₂ monolayers with the 2H phase.

FIG. 31e shows the corresponding FFT pattern of the as-synthesized freestanding MoS₂ monolayers with the 2H phase.

FIG. 32 shows the XPS spectra of 4H—Au@1T′-MoS₂, freestanding MoS₂ monolayer, and commercial 2H—MoS₂.

FIG. 33 shows the Raman spectra of 4H—Au@1T′-MoS₂, freestanding MoS₂ monolayer, and commercial 2H—MoS₂.

FIG. 34a shows the low-magnification SEM image of 4H—Au@1T′-MoSe₂.

FIG. 34b shows the statistic histograms showing the length of 4H—Au@1T′-MoSe₂ in FIG. 34a.

FIG. 35a shows the low-magnification TEM image of 4H—Au@1T′-MoSe₂.

FIG. 35b shows the TEM image of a typical 4H—Au@1T′-MoSe₂.

FIG. 36a shows the STEM image of a 4H—Au@1T′-MoSe₂.

FIG. 36b shows the HAADF-STEM image of a single segment of a 4H—Au@1T′-MoSe₂ recorded from the blue area in FIG. 36a.

FIG. 36c shows the corresponding FFT pattern recorded from the pink dashed area in FIG. 36b.

FIG. 36d shows the atomic-resolution HAADF-STEM image recorded from the blue area in FIG. 36b.

FIG. 36e shows the intensity profile along the red line in FIG. 36d, confirming the 1T′-MoSe₂ monolayer.

FIG. 36f shows the atomic-resolution HAADF-STEM image recorded from the blue area in FIG. 36d, indicating a regular growth relationship between 4H—Au and 1T′-MoSe₂ monolayer.

FIG. 37a shows the STEM image of a single segment of a 4H—Au@1T′-MoSe₂.

FIG. 37b shows the corresponding EDS elemental line scan along the pink dashed line in FIG. 37a.

FIG. 37c shows the corresponding EDS elemental mapping of a single segment of a 4H—Au@1T′-MoSe₂, indicating the uniform growth of MoSe₂ on the surface of 4H—Au.

FIG. 38a shows the TEM image of the synthesized freestanding MoSe₂ monolayers in the absence of 4H—Au substrates.

FIG. 38b shows the HRTEM image of the as-synthesized freestanding MoSe₂ monolayers with 1T′ phase.

FIG. 38c shows the corresponding FFT pattern of the as-synthesized freestanding MoSe₂ monolayers with 1T′ phase.

FIG. 38d shows the HRTEM image of the as-synthesized freestanding MoSe₂ monolayers with the 2H phase.

FIG. 38e shows the corresponding FFT pattern of the as-synthesized freestanding MoSe₂ monolayers with the 2H phase.

FIG. 39 shows the XPS spectra of 4H—Au@1T′-MoSe₂, freestanding MoSe₂ monolayer, and commercial 2H—MoSe₂.

FIG. 40 shows the Raman spectra of 4H—Au@1T′-MoSe₂, freestanding MoSe₂ monolayer, and commercial 2H—MoSe₂.

FIG. 41a shows the ABF-STEM image and the corresponding schematic illustration of the growth process of 1T′-WSe₂ monolayer on 4H—Au extracted at ˜30 s.

FIG. 41b shows the ABF-STEM image and the corresponding schematic illustration of the growth process of 1T′-WSe₂ monolayer on 4H—Au extracted at ˜60 s.

FIG. 41c shows the ABF-STEM image and the corresponding schematic illustration of the growth process of 1T′-WSe₂ monolayer on 4H—Au extracted at ˜90 s.

FIG. 41d shows the atomic-resolution ABF-STEM image and simulated model of the interface between 1T′-WSe₂ monolayer and 4H—Au.

FIG. 42a shows the Raman spectra of 4H—Au@1T′-WS₂ annealed at 298 K, 373 K, 473 K, 573 K, and 673 K for 30 min, respectively.

FIG. 42b shows the Raman spectra of freestanding WS₂ monolayer annealed at 298 K, 373 K, 473 K, 573 K, and 673 K for 30 min, respectively.

FIG. 43a shows the Raman spectra of 4H—Au@1T′-WSe₂ annealed at 298 K, 373 K, 473 K, 573 K, and 673 K for 30 min, respectively.

FIG. 43b shows the Raman spectra of freestanding WSe₂ monolayer annealed at 298 K, 373 K, 473 K, 573 K, and 673 K for 30 min, respectively.

FIG. 44a shows the low-magnification SEM image of 2H/fcc-Au nanosheets.

FIG. 44b shows the low-magnification TEM image of 2H/fcc-Au nanosheets.

FIG. 44c shows the TEM image of a typical 2H/fcc-Au nanosheet.

FIG. 44d shows the atomic-resolution HAADF-STEM image of the 2H/fcc edge of a single 2H/fcc-Au nanosheet, indicating the co-existence of 2H phase and fcc phase in a 2H/fcc-Au nanosheet.

FIG. 45a shows the low-magnification SEM image of 4H/fcc-Au nanorods.

FIG. 45b shows the low-magnification TEM image of 4H/fcc-Au nanorods.

FIG. 45c shows the HRTEM image of a single segment of a typical 4H/fcc-Au nanorod.

FIG. 45d shows the corresponding FFT pattern in FIG. 45c, indicating the co-existence of 4H phase and fcc phase in a 4H/fcc-Au nanorod.

FIG. 46a shows the low-magnification TEM images of fcc-Au nanoparticles.

FIG. 46b shows the HAADF-STEM image of a typical fcc-Au nanoparticle.

FIG. 47a shows the low-magnification TEM image.

FIG. 47b shows the HAADF-STEM image of fcc-Au nanocubes.

FIG. 47c shows the atomic-resolution HAADF-STEM image of a typical fcc-Au nanocube.

FIG. 47d shows the corresponding FFT pattern of FIG. 47c.

FIG. 48a shows the low-magnification SEM image.

FIG. 48b shows the low-magnification TEM image of fcc-Au nano-octahedra.

FIG. 48c shows the ABF-STEM image of a typical fcc-Au octahedron.

FIG. 48d shows the corresponding FFT pattern.

FIG. 49a shows the low-magnification TEM images of fcc-Au nanorods.

FIG. 49b shows the HRTEM image of a typical fcc-Au nanorod.

FIG. 50a shows the low-magnification TEM images of fcc-Ag nanowires.

FIG. 50b shows the HRTEM images of a fcc-Ag nanowire.

FIG. 51a shows the low-magnification TEM image of fcc-Ag nanoparticles.

FIG. 51b shows the XRD pattern of fcc-Ag nanoparticles.

FIG. 51c shows the STEM image of fcc-Ag nanoparticles.

FIG. 52a shows the low-magnification TEM images of amorphous Pd nanoparticles.

FIG. 52b shows the HRTEM of a typical amorphous Pd nanoparticle.

FIG. 52c shows the SAED pattern of amorphous Pd nanoparticles in FIG. 52a.

FIG. 53a shows the STEM image of a typical 2H/fcc-Au@ 1T′/1T-WS₂ nanosheet.

FIG. 53b shows the atomic-resolution HAADF-STEM image of the interface between 1T′/1T-WS₂ and 2H/fcc-Au, showing the typical phase-selective growth of 1T′/1T-WS₂ on 2H/fcc-Au NS.

FIG. 53c shows the EDS elemental mappings of a 2H/fcc-Au@1T′/1T-WS₂ NS.

FIG. 53d shows the atomic-resolution HAADF-STEM image showing the interface of 1T′-WS₂/2H—Au(110).

FIG. 53e shows the atomic-resolution HAADF-STEM image showing the interface of 1T-WS₂/fcc-Au(100).

FIG. 53f shows the corresponding integrated pixel intensity profiles of 1T′-WS₂ ML in red rectangle and 2H—Au(110) in blue rectangle in FIG. 53d, and 1T-WS₂ ML in pink rectangle and fcc-Au(100) in green rectangle in FIG. 53e, respectively.

FIG. 54a shows the HAADF-STEM images of a segment of a 4H/fcc-Au@1T′/1T-WS₂ NR.

FIG. 54b shows the atomic-resolution HAADF-STEM image of the interface between 1T′/1T-WS₂ and 4H/fcc-Au, showing the typical phase-selective growth of 1T′/1T-WS₂ on 4H/fcc-Au NR.

FIG. 54c shows the EDS elemental mappings of a segment of a 4H/fcc-Au@ 1T′/1T-WS₂ NR.

FIG. 54d shows the atomic-resolution ABF-STEM image showing the interface of 1T′-WS₂/4H—Au(110).

FIG. 54e shows the atomic-resolution ABF-STEM image showing the interface of 1T-WS₂/fcc-Au(111).

FIG. 54f shows the corresponding integrated pixel intensity profiles of 1T′-WS₂ ML in red rectangle and 4H—Au(110) in blue rectangle in FIG. 54d, and 1T-WS₂ ML in pink rectangle and fcc-Au(111) in green rectangle in FIG. 54e, respectively.

FIG. 55a shows the low-magnification TEM image of fcc-Au@1T′-WS₂ nanoparticles

FIG. 55b shows the HRTEM image of fcc-Au@ 1T′-WS₂ nanoparticles

FIG. 55c shows the atomic-resolution HAADF-STEM images of a fcc-Au@ 1T′-WS₂ nanoparticle, showing the interface of 1T′-WS₂ and fcc-Au nanoparticle.

FIG. 55d shows the EDS elemental mappings of a fcc-Au@ 1T′-WS₂ nanoparticle.

FIG. 55e shows the atomic-resolution HAADF-STEM image showing the interface between 1T′-WS₂ ML and Au nanoparticle.

FIG. 55f shows the corresponding integrated pixel intensity profiles of 1T′-WS₂ ML in red rectangle in FIG. 55e.

FIG. 56a shows the low-magnification STEM image of fcc-Au@1T-WS₂ nanocubes.

FIG. 56b shows the HAADF-STEM image of fcc-Au@ 1T-WS₂ nanocubes.

FIG. 56c shows the HAADF-STEM image of a typical fcc-Au@ 1T-WS₂ nanocube.

FIG. 56d shows the EDS elemental mappings of a fcc-Au@ 1T-WS₂ nanocube.

FIG. 56e shows the atomic-resolution ABF-STEM image showing the interface between 1T-WS₂ ML and (100) facet of fcc-Au nanocube.

FIG. 56f shows the atomic-resolution ABF-STEM image showing the interface between 1T-WS₂ ML and (111) facet of fcc-Au nanocube.

FIG. 56g shows the corresponding integrated pixel intensity profiles of 1T-WS₂ ML in pink rectangle and fcc-Au(100) in blue rectangle in FIG. 56e, and 1T-WS₂ ML in pink rectangle and fcc-Au(111) in green rectangle in FIG. 56f, respectively.

FIG. 57a shows the TEM image of fcc-Au@ 1T-WS₂ nano-octahedra.

FIG. 57b shows the HAADF-STEM image of a fcc-Au@1T-WS₂ nano-octahedron.

FIG. 57c shows the atomic-resolution HAADF-STEM image showing the interface between 1T-WS₂ ML and (111) facet of fcc-Au octahedron.

FIG. 57d shows the SAEED corresponding integrated pixel intensity profiles of 1T-WS₂ ML in pink rectangle and fcc-Au(111) in blue rectangle in FIG. 57c.

FIG. 57e shows the corresponding EDS elemental mappings of a fcc-Au@1T-WSe₂ octahedron.

FIG. 58a shows the HAADF-STEM images of fcc-Au@ 1T-WS₂ nanorods.

FIG. 58b shows the HAADF-STEM images of a typical fcc-Au@ 1T-WS₂ nanorod

FIG. 58c shows the atomic-resolution HAADF-STEM images showing the interface between 1T-WS₂ ML and fcc-Au nanorod.

FIG. 58d shows the atomic-resolution HAADF-STEM images showing the interface between 1T-WS₂ ML and fcc-Au nanorod.

FIG. 58e shows the EDS elemental mappings of a fcc-Au@1T-WS₂ nanorod.

FIG. 58f shows the atomic-resolution ABF-STEM image showing the interface between 1T-WS₂ ML and (110) facet of fcc-Au nanorod.

FIG. 58g shows the atomic-resolution ABF-STEM image showing the interface between 1T-WS₂ ML and (111) facet of fcc-Au nanorod.

FIG. 58h shows the corresponding integrated pixel intensity profiles of 1T-WS₂ ML in pink rectangle and fcc-Au(110) in blue rectangle in FIG. 58f, and 1T-WS₂ ML in pink rectangle and fcc-Au(111) in green rectangle in FIG. 58g, respectively.

FIG. 59a shows the low-magnification TEM images of fcc-Ag@1T-WS₂ nanowires.

FIG. 59b shows the HRTEM image of a typical fcc-Ag@1T-WS₂ nanowire.

FIG. 60a shows the low-magnification TEM images of fcc-Ag@1T-WS₂ nanoparticles.

FIG. 60b shows the HRTEM image of a typical fcc-Ag@1T-WS₂ nanoparticles.

FIG. 61a shows the TEM image of amorphous Pd@ 1T′-WS₂ nanoparticles.

FIG. 61b shows the XRD pattern of amorphous Pd@ 1T′-WS₂ nanoparticles.

FIG. 61c shows the HAADF-STEM image of amorphous Pd@ 1T′-WS₂ nanoparticles.

FIG. 61d shows the atomic-resolution HAADF-STEM image of a typical amorphous Pd@ 1T′-WS₂ nanoparticle.

FIG. 62 shows the Raman-FL spectra of R6G (10⁻⁹ M concentration) coated on the 4H—Au@1T′-WS₂ and bare SiO₂.

FIG. 63a shows the AFM image of a single 1T′-WS₂ monolayer mechanically exfoliated from 1T′-WS₂ crystal by scotch tape.

FIG. 63b shows the Raman spectrum of a single 1T′-WS₂ monolayer mechanically exfoliated from 1T′-WS₂ crystal by scotch tape.

FIG. 64a shows the AFM image of a single 1H—WS₂ mechanically exfoliated from 2H—WS₂ crystal by scotch tape.

FIG. 64b shows the Raman spectrum of a single 1H—WS₂ mechanically exfoliated from 2H—WS₂ crystal by scotch tape.

FIG. 65 shows the Raman spectra of R6G coated on the 4H—Au@1T′-WS₂, 4H—Au, 1T′-WS₂ monolayer, 1T′/2H-WS₂ monolayer, 2H—WS₂ monolayer, and bare SiO₂/Si with a fixed concentration of 10⁻¹² M.

FIG. 66 shows the Raman spectra of bulk R6G (0.1 M R6G coated on bare SiO₂/Si substrate) with an applied laser power of 1 and 0.1 mW, respectively. The acquisition time is 0.4 s.

FIG. 67a shows the SERS spectra of CV coated on 4H—Au@1T′-WS₂ with various concentrations from 10⁻⁸ M to 10⁻¹⁶ M.

FIG. 67b shows the calculated Raman enhancement factors from the peak intensity (1617 cm⁻¹) of CV at different concentrations in FIG. 67a.

FIG. 68a shows the SERS spectra of MB coated on 4H—Au@1T′-WS₂ with various concentrations from 10⁻⁶ M to 10⁻¹⁴ M.

FIG. 68b shows the calculated Raman enhancement factors from the peak intensity (1622 cm⁻¹) of MB at different concentrations in FIG. 68a.

FIG. 69 shows the photostability of the SERS spectra of R6G (10⁻⁹ M concentration) coated on 4H—Au@1T′-WS₂ in 6 min. Each of the 12 spectra was acquired with an integration time of 10 s.

FIG. 70a shows the optical microscope images of the bare PDMS.

FIG. 70b shows the optical microscope images of the SiO₂/PDMS.

FIG. 70c shows the optical microscope images of the 4H—Au@1T′-WS₂/SiO₂/PDMS.

FIG. 70d shows the optical microscope images of the 4H—Au@1T′-WS₂/SiO₂/PDMS SERS tape covered with SARS-CoV-2 S protein.

FIG. 71 shows the Raman spectra of SARS-CoV-2 S protein (Wild Type) coated on the 4H—Au@1T′-WS₂ with various concentrations from 10⁻⁹ M (nM) to 1018 M (aM).

### DETAILED DESCRIPTION

A low-temperature and rapid wet-chemical synthetic method to directly synthesize 1T′-TMD monolayers is provided. The 1T′-TMD monolayers may be formed on a substrate such as gold nanomaterials (e.g., 4H-phase gold nanowires). A transition metal precursor and a first solvent are mixed to form a first mixture. A non-oxygen chalcogen or non-oxygen chalcogen precursor and a second solvent are mixed to form a second mixture. The first mixture is rapidly injected into the second mixture at a temperature between approximately 250 and 350° C. to form a third mixture. 1T′-transition metal dichalcogenide monolayers are recovered from the third mixture, typically through centrifugation. As used herein, the term “rapid” means that the first mixture is completely enveloped by the second mixture within a period of time of 1-3 seconds.

The transition metals may be molybdenum or tungsten while the non-oxygen chalcogens may be sulfur, selenium, tellurium. The chalcogens may be in the form of compounds, including diphenyl disulfide, diphenyl diselenide, diphenyl ditelluride. However, other chalcogen precursors may be used.

Particular precursors for the transition metals include ammonium tungsten oxide, ammonium molybdate, molybdenum(V) chloride or tungsten (VI) chloride; however, other precursors that will react with chalcogens may also be selected. In particular, precursors that are compatible with the selected solvents are used, such as precursors that are capable of dissolving in the selected solvents.

The first solvent may be oleylamine. The solvent is selected because oleylamine is a positively charged strong coordinating solvent which can bind tightly with the transition metal precursors to form a uniform solution. Oleylamine may also form complexes (e.g., ligand complexes) with the metal ions of the precursor. As a result, metastable materials may be formed that can act as secondary precursors and thus be decomposed in a controlled way to yield a selected structure. As an example, the first mixture may include 1-3 mg/mL, more particularly, 1.5-2 mg/mL transition metal precursor in 0.5 milliliters of oleylamine.

In a further aspect, the second mixture solvent may be octadecylamine or a combination of oleylamine and octadecene. The octadecylamine or oleylamine may act as a cationic surfactant that ensures an even dispersion of the non-oxygen chalcogen. When the first mixture is added to the second mixture, negatively charged [WS₂]⁻ nuclei are first formed, and stabilized on either side by positively charged octadecylamine or oleylamine ligands through electrostatic interactions. The octadecylamine or oleylamine solvents may prevent the aggregation and thickness growth along the Z-direction of the nanosheets, resulting in the formation of monolayers. Moreover, the octadecylamine or oleylamine may also stabilize the metastable crystal structure and prevent its transition to the thermodynamically stable structure. The synthesis of metastable 1T′-TMD monolayers is a kinetically and thermodynamically balanced process. Here, octadecene is used to modulate the concentration of octadecylamine or oleylamine in the solvent to control the reaction kinetics. These solvents facilitate the controlled reaction of the transition metal precursor with the chalcogen to create the desired monolayer product.

Using the techniques of the present invention, 1T′-transition metal dichalcogenide monolayers may be formed including MoS₂, WS₂, MoSe₂, WSe₂, or MoTe₂ monolayers.

When forming the monolayers on a substrate, metal materials may be selected. In one aspect, the metal material may be gold. The gold substrate material may have a particular shaped structure, such as Au nanoparticles. In particular, the Au nanoparticles may be 4H—Au nanowires. When Au particles are used, they are added to the first mixture that is injected into to the second mixture. The Au nanoparticles help ensure that the 1T′-phase of the metal dichalcogenide is formed. Besides, 4H—Au nanowires, other metal nanomaterials, including 2H/fcc-Au nanosheets, 4H/fcc-Au nanorods, fcc-Au nanoparticles, fcc-Ag nanoparticles and amorphous Pd nanoparticles can be used as substrates to grow 1T′-TMDs in a similar synthetic strategy.

In one embodiment, the 1T′-transition metal dichalcogenide monolayers on 4H—Au nanowires may be deposited on a polymer substrate, such as PDMS, having a hard transparent coating such as silica formed on the surface. This substrate is used in surface-enhanced Raman spectroscopy (SERS).

### EXAMPLES

The rapid wet-chemical synthetic method described above was used to directly synthesize four kinds of 1T′-TMD monolayers (e.g., 1T′-WS₂, WSe₂, MoS₂, and MoSe₂) on 4H—Au nanowires (NWs) to prepare a series of 4H—Au@1T′-TMDs. The as-prepared 1T′-TMD monolayers on 4H—Au exhibit the pure 1T′ phase. The 1T′-TMD monolayers on 4H—Au are purified and stabilized by the strong Au—S/Se interfacial interaction between 1T-TMDs and 4H—Au. The as-prepared 4H—Au@1T′-TMDs have been characterized by the scanning electron microscopy (SEM), high-resolution transition electron microscopy (HRTEM), aberration-corrected high-angle annular dark-field scanning transmission electron microscopy (HAADF-STEM), annular bright-field STEM (ABF-STEM), X-ray diffraction (XRD), X-ray photoelectron spectroscopy (XPS), Raman spectroscopy, X-ray absorption near edge structure (XANES), and extended X-ray absorption fine structure (EXAFS). As a proof-of-concept application, a single 4H—Au@1T′-WS₂ was used as a SERS-active platform to investigate the intrinsic SERS performance. The limit of detection (LOD) and enhanced factor (EF) of a typical dye analyte, Rhodamine 6G (R6G) on a single 4H—Au@1T′-WS₂ could reach 10⁻¹⁸ M and 1.69×10¹⁵, respectively. Notably, we fabricated the 4H—Au@ 1T′-WS₂/SiO₂/PDMS SERS tape to detect the SARS-CoV-2 S protein (Omicron/B.1.1.529 variant), and the LOD of Omicron variant S protein was as low as 10⁻¹⁸ M. The ultrasensitive SERS performance of the 4H—Au@1T′-WS₂ could be ascribed to the enriched molecular adsorption, efficient charge transfer of single-layer 1T′-WS₂, the strong electromagnetic field of 4H—Au, as well as the synergistic effect between 4H—Au and 1T′-WS₂.

Wet-chemical synthesis of 1T′-TMD monolayers on 4H—Au.

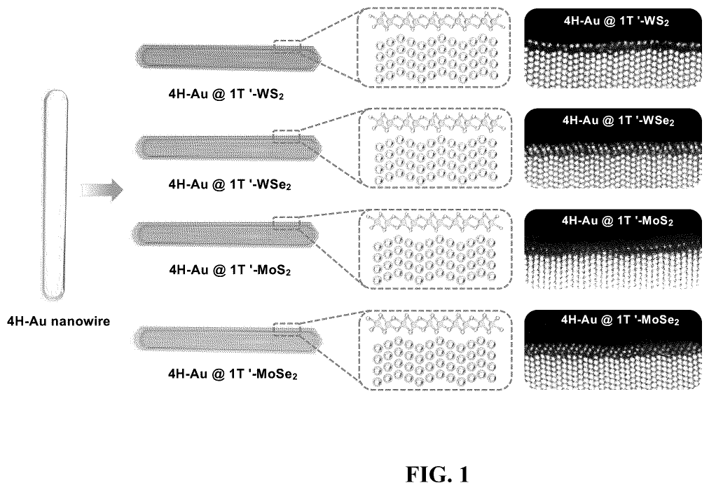

As illustrated in the scheme for the synthesis of 4H—Au@1T′-TMDs in FIG. 1, a low-temperature and rapid wet-chemical synthetic method is developed to directly synthesize four kinds of 1T′-TMD monolayers, including 1T′-WS₂, WSe₂, MoS₂, and MoSe₂ on 4H—Au. To prepare 4H—Au@1T′-TMDs, Au NWs with a high 4H phase purity were first synthesized (as set forth in detail below). Then, by using the 4H—Au as seeds, a series of 1T′-TMD monolayers, including WS₂, WSe₂, MoS₂, and MoSe₂ may be synthesized on 4H—Au to construct the 4H—Au@1T′-TMDs via the wet-chemical method.

Chemical Sources: Ammonium tungsten oxide ((NH₄)₂WO₄, 99.99+%) was purchased from Alfa Aesar, ammonium molybdate ((NH₄)₂MoO₄, 99.98%), sulfur powder (S, 99.98%), selenium powder (Se, 99.99%), octadecylamine (technical grade, 90%), oleylamine (OM, >98%), oleylamine (OM, technical grade, 70%), 1-octadecene (ODE, technical grade, 90%), trioctylphosphine (TOP, 97%), gold (III) chloride hydrate (HAuCl₄·3H₂O, ˜49% Au basis), N-ethylcyclohexylamine (99%), 1,2-dichloropropane (99%), hexane (technical grade) were purchased from Sigma-Aldrich, hydrochloric acid (technical grade), toluene (technical grade, >99%), and ethanol (AR) were used as received without further purification. Rhodamine 6G (R6G), crystal violet (CV), and methylene blue (MB) were purchased from Sinopharm Chemical Reagent Co., Ltd.

Synthesis of 4H—Au NWs.

In a typical synthesis, 20 mg of HAuCl₄-3H₂0, 1.5 mL of OM (98%), 400 μL of N-ethylcyclohexylamine, 20 mL of hexane, and 200 μL of 1,2-dichloropropane were thoroughly mixed in a 40 ml glass vial. The vial was then sealed with PTFE tape and parafilm before being heated for 48 h in an oven pre-set at 57° C. The product was collected by centrifugation (4000 rpm, 3 min), washed with toluene three times, and then redispersed in 10 mL of toluene. The yield of 4H—Au NWs was about 2.5 mg.

Synthesis of 4H—Au@1T′-WS₂ NWs

1.8 g octadecylamine, 3 mL ODE, and 1.6 mg sulfur powder were added to a 50 mL three-neck flask. The mixture was degassed upon heating at 120° C. under vacuum with vigorous magnetic stirring for 30 minutes. Then, the mixture was purged with Ar and heated to 290° C. Meanwhile, 2 mL as-prepared 4H—Au toluene solution was centrifuged, then redispersed in 500 μL of OM (70%) with 1 mg (NH₄)₂WO₄, and sonicated for 10 min to form a homogeneous solution. Then the solution was degassed and then purged with Ar. When the temperature of the mixture reached 290° C., the aforementioned homogeneous solution was rapidly injected into the mixture. After 3 min, the colloidal solution was cooled down to room temperature. The obtained 4H—Au@1T′-WS₂ were collected by centrifugation at 4000 rpm for 3 min, and then dispersed in a 10 mL mixture of ethanol and hydrochloric acid (v/v=9/1). The obtained solution was continuously stirred under Ar atmosphere for 1 h to remove the surfactants and tungsten oxides on 4H—Au@1T′-WS₂. After that, the 4H—Au@1T′-WS₂ were collected by centrifugation, and then redispersed in 2 mL ethanol for storage.

Synthesis of 4H—Au@1T′-WSe₂ NWs.

2 mL OM (70%), 3 mL ODE, and 2 mg selenium powder were added into a 50 mL three-neck flask. The mixture was degassed upon heating at 120° C. under vacuum with vigorous magnetic stirring for 30 minutes. Then, the mixture was purged with Ar and heated to 310° C. Meanwhile, 2 mL as-prepared 4H—Au toluene solution was centrifuged, then redispersed in 500 μL of OM (70%) with 1 mg (NH₄)₂WO₄, and sonicated for 10 min to form a homogeneous solution. Then the solution was degassed and then purged with Ar. When the temperature of the mixture reached 310° C., the aforementioned homogeneous solution was rapidly injected into the mixture. After 3 min, the colloidal solution was cooled down to room temperature. Then 200 μL of TOP was injected into the mixture at 80° C. to remove excess selenium. The rest procedures to purify 4H—Au@1T′-WSe₂ are similar to those for the 4H—Au@1T′-WS₂.

Synthesis of 4H—Au@1T′-MoS₂ NWs.

1.8 g octadecylamine, 3 mL ODE, and 1.6 mg sulfur powder were added to a 50 mL three-neck flask. The mixture was degassed upon heating at 120° C. under vacuum with vigorous magnetic stirring for 30 minutes. Then, the mixture was purged with Ar and heated to 280° C. Meanwhile, 2 mL as-prepared 4H—Au toluene solution was centrifuged, then redispersed in 500 μL of OM (70%) with 0.7 mg (NH₄)₂MoO₄, and sonicated for 10 min to form a homogeneous solution. Then the solution was degassed and then purged with Ar. When the temperature of the mixture reached 280° C., the aforementioned homogeneous solution was rapidly injected into the mixture. After 3 min, the colloidal solution was cooled down to room temperature. The rest procedures to purify 4H—Au@1T′-MoS₂ are similar to those for the 4H—Au@1T′-WS₂.

Synthesis of 4H—Au@1T′-MoSe₂ NWs. 2 mL OM (70%), 3 mL ODE, and 2 mg selenium powder were added into a 50 mL three-neck flask. The mixture was degassed upon heating at 120° C. under vacuum with vigorous magnetic stirring for 30 minutes. Then, the mixture was purged with Ar and heated to 300° C. Meanwhile, 2 mL as-prepared 4H—Au toluene solution was centrifuged, then redispersed in 500 μL of OM (70%) with 0.7 mg (NH₄)₂MoO₄, and sonicated for 10 min to form a homogeneous solution. Then the solution was degassed and then purged with Ar. When the temperature of the mixture reached 300° C., the aforementioned homogeneous solution was rapidly injected into the mixture. After 3 min, the colloidal solution was cooled down to room temperature. Then 200 μL of TOP was injected into the mixture at 80° C. to remove excess selenium. The rest procedures to purify 4H—Au@1T′-MoSe₂ are similar to those for the 4H—Au@1T′-WS₂.

Synthesis of Freestanding 2H/1T′-WS₂ Monolayers.

The procedures for the synthesis of 1T′-WS₂ monolayers are the same as those for the 4H—Au@1T′-WS₂ except for the absence of 4H—Au.

Synthesis of Freestanding 2H/1T′-WSe₂ Monolayers.

The procedures for the synthesis of 1T′-WSe₂ monolayers are the same as those for the 4H—Au@1T′-WSe₂ except for the absence of 4H—Au.

Synthesis of Freestanding 2H/1T′-MoS₂ Monolayers

The procedures for the synthesis of 1T′-MoS₂ monolayers are the same as those for the 4H—Au@1T′-MoS₂ except for the absence of 4H—Au.

Synthesis of Freestanding 2H/1T′-MoSe₂ Monolayers

The procedures for the synthesis of 1T′-MoSe₂ monolayers are the same as those for the 4H—Au@1T′-MoSe₂ except for the absence of 4H—Au.

Preparation of 4H—Au NWs

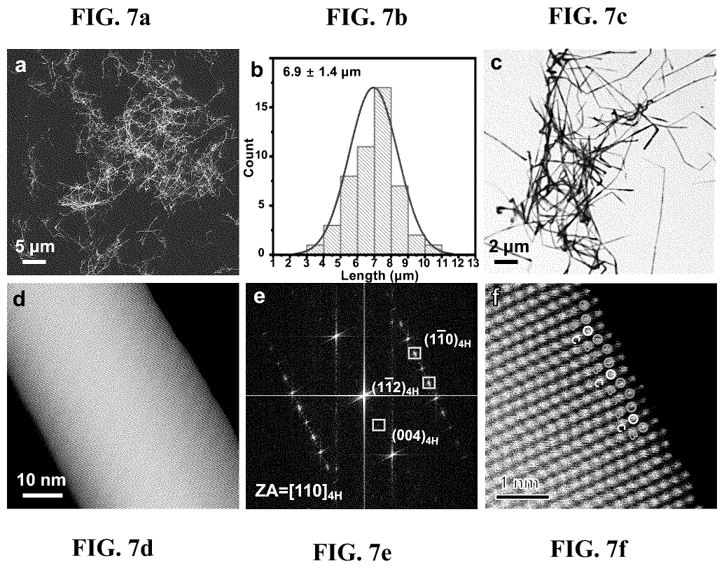

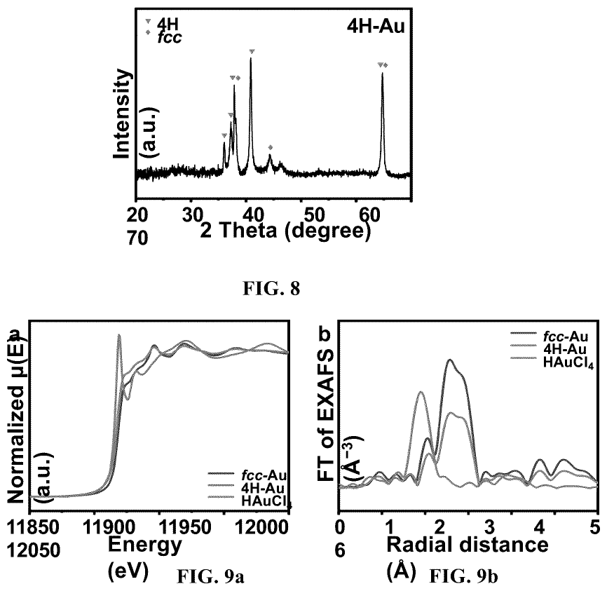

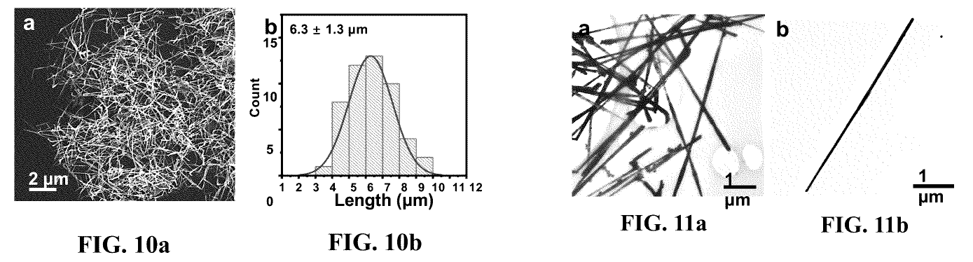

To prepare 4H—Au@1T′-TMDs, 4H—Au NWs were first synthesized by heating the mixture of HAuCl₄-3H₂O, oleylamine, N-ethylcyclohexylamine, hexane, and 1,2-dichloropropane at 57° C. in an oven for 48 h. The as-prepared 4H—Au NWs are relatively longer and straighter than the previously reported 4H—Au nanoribbons, displaying an average length of 6.9±1.4 μm, characterized by low-magnification SEM (FIG. 7a, 7b) and TEM (FIG. 7c). The HAADF-STEM images (FIG. 7d, 7f) and the corresponding fast Fourier transform (FFT) pattern (FIG. 7e) show that 4H—Au possesses a high 4H phase purity, which is also confirmed by the XRD pattern (FIG. 8). XANES and EXAFS were combined to reveal the electronic structure and coordination environment of 4H—Au. As shown in FIG. 9a, in the Au L₃-edge, the white line intensity of 4H—Au is higher than that of fcc-Au, indicating a higher chemical valence of 4H—Au. The Fourier transforms of EXAFS (FT-EXAFS) demonstrate that the 4H—Au exhibits a lower coordination number (CN) and wider distribution of Au—Au bond length in comparison with those of fcc-Au, implying the formation of an unconventional 4H phase (FIG. 9b).

Preparation of 4H—Au@1T′-WS₂/SiO₂/PDMS tape for SARS-CoV-2 S Protein Detection

50-nm-thick SiO₂ was first deposited on a PDMS film by using a radio frequency (rf) magnetron sputtering physical vapor deposition (PVD) system (Kurt J. Lesker, PVD75, USA). The sputtering target was a 3-inch SiO₂, fused quartz (99.995% purity) supplied by Kurt J. Lesker, USA. The PDMS films were fixed directly above the target and a mechanical shutter was attached to the target. The SiO₂/PDMS tape was fabricated after the deposition at 150 W rf power under 3 mTorr for 250 s. Then 10 μL of ethanol solution of 4H—Au@1T′-WS₂ is dropped on the surface of the SiO₂/PDMS tape. After drying at 60° C. for 30 min, the fabricated flexible 4H—Au@1T′-WS₂/SiO₂/PDMS tape was ready for the SERS detection of SARS-CoV-2 S protein.

Characterizations. Transmission electron microscopy (TEM) and dark-field scanning TEM (DF-STEM) images were obtained by using JEOL 2100F (Japan) operated at 200 kV. The high-angle annular DF-STEM (HAADF-STEM), annular bright-field STEM images, and energy dispersive X-ray spectroscopy (EDS) results were obtained by JEOL ARM200F (JEOL, Tokyo, Japan) operated at 200 kV with cold field emission gun. Scanning electron microscope (SEM) images and energy-dispersive X-ray spectroscopy (EDS) spectra were recorded on a scanning electron microscope (Thermo Fisher Scientific, QUATTRO S). Rigaku SmartLab and Bruker D8 ADVANCE X-ray powder diffractometers, using Cu Kα radiation source (λ=1.5406 Å), were used to measure the X-ray diffraction (XRD) patterns of all the samples. The concentrations of Au, W, and S were measured by inductively coupled plasma optical emission spectrometry (ICP-OES, PerkinElmer, Optima 8000DV). XPS measurements were carried out on a VG ESCALAB 220I-XL system. C is peak (284.8 eV) was used to calibrate the binding energy of other elements. Raman spectra were obtained on a WITec system (Germany) with an excitation wavelength of 532 nm. The extended X-ray absorption fine structure (EXAFS) and X-ray absorption near edge structure (XANES) of W L3-edge were performed at the 7-BM/QAS beamline of the National Synchrotron Light Source II (NSLS-II). The storage ring of NSLS-II operated at E=3 GeV and I=400 mA under the top-off mode. The X-ray radiation was monochromatized by the Si (111) channel-cut monochromator. W foil was used as a reference for energy calibration, and all samples were measured in the transmission mode at room temperature. Demeter software package was used for the data processing and fitting of all the measured data

Results

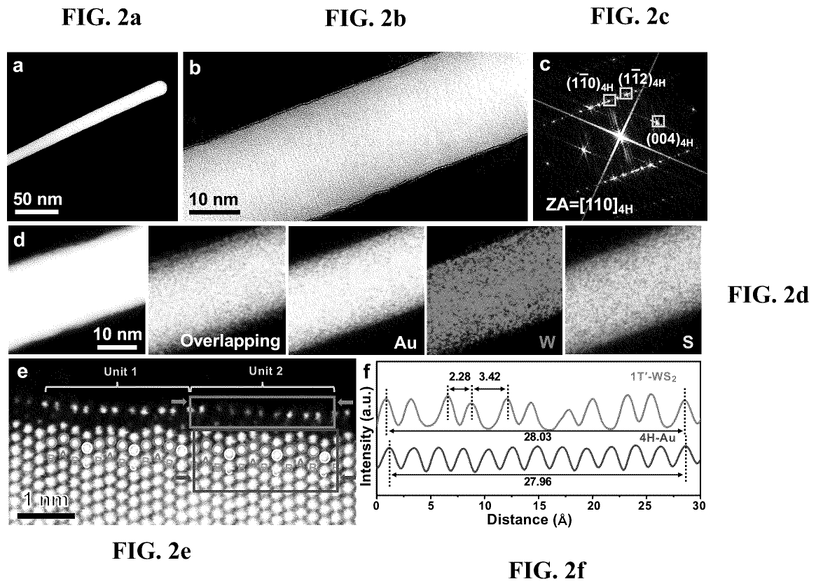

The controlled synthesis of 4H—Au@1T′-WS₂ is taken as an example. Briefly, a mixture of (NH₄)₂WO₄ and the 4H—Au seeds in oleylamine was rapidly injected into the hot octadecylamine, 1-octadecene, and sulfur powder mixture at a temperature of 290° C. under flowing argon. After maintaining at 290° C. for 3 minutes, the 4H—Au@1T′-WS₂ was formed. As depicted in the SEM (FIG. 10) and TEM images (FIG. 11), the as-prepared 4H—Au@1T′-WS₂ maintains the initial morphology of 4H—Au and exhibits an average length of 6.3±1.3 μm (FIG. 10b). The enlarged HAADF-STEM image (FIG. 2b) of a single segment taken from atypical 4H—Au@ 1T′-WS₂(FIG. 2a) reveals that a well-defined single-layer WS₂, in which a layer of W atoms is sandwiched between two layers of S atoms, is uniformly formed on the 4H—Au surface due to the strong affinity of Au to S atoms.

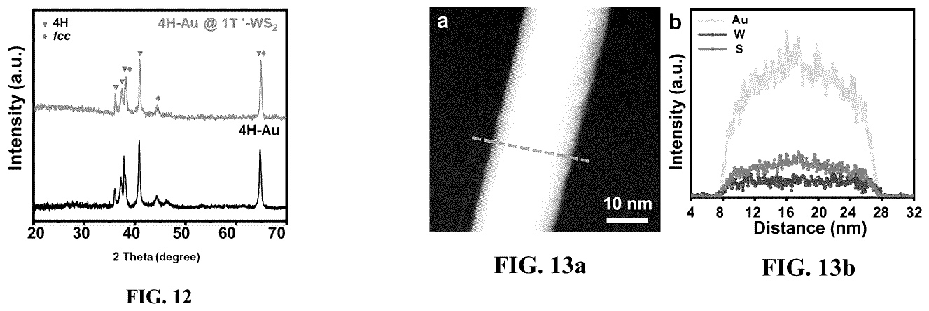

The HAADF-STEM image (FIG. 2b) and the corresponding FFT pattern (FIG. 2c) show that after the growth of 1T′-WS₂, the Au NWs still maintain the 4H phase, that is, ABCB stacking, suggesting the superior stability of 4H—Au under the high reaction temperature (290° C.), which is also evidenced by XRD pattern (FIG. 12). The characteristic peaks of 1T′-WS₂ cannot be observed from the XRD pattern, implying the single-layer nature of 1T′-WS₂. The STEM-energy-dispersive X-ray spectroscopy (EDS) element mappings (FIG. 2d) and the STEM-EDS line scanning profiles (FIG. 13) corroborate the even distribution of Au, W, and S in the 4H—Au@1T′-WS₂, implying the core-shell structure formed by the uniform growth of WS₂ on the surface of 4H—Au.

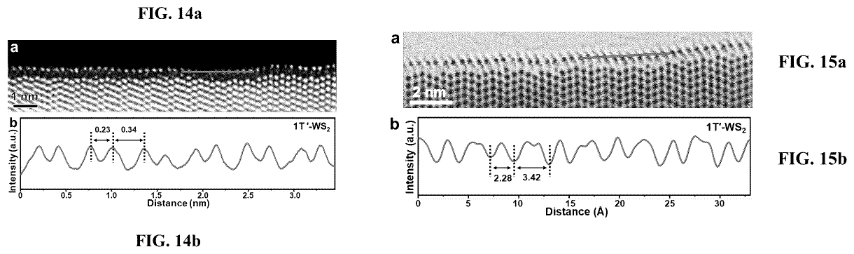

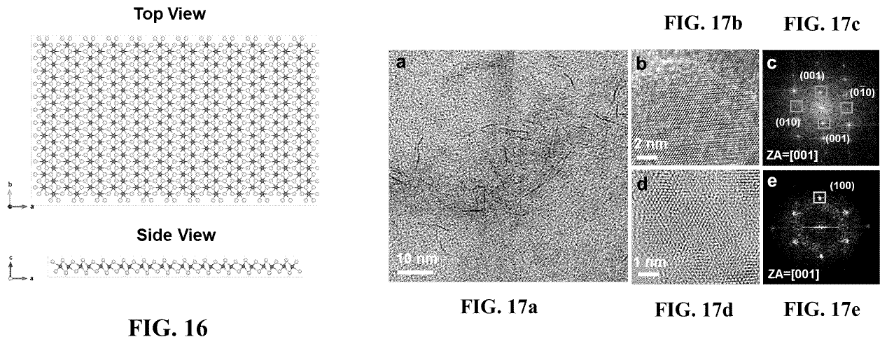

The detailed crystal structure of the 1T′-WS₂ was further characterized by the atomic-resolution HAADF-STEM and ABF-STEM. As known, the zig-zag chains of transition metal atoms are widely referred to as a typical feature of 1T′ polymorph. As illustrated in FIG. 14 and FIG. 15, the atomic-resolution HAADF-STEM and ABF-STEM images clearly show that the as-prepared WS₂ monolayers on the surface of 4H—Au only possess the 1T′ phase, respectively. And the corresponding intensity profiles of WS₂ (FIG. 14b, FIG. 15b) display two different W—W distances of ˜0.23 nm and 0.34 nm, which are in good accordance with the short W—W distance (0.2264 nm) and the long W—W distance (0.3411 nm) of the 1T′-WS₂ monolayer crystal model observed along the a-axis from the side view, respectively (FIG. 16).

The intimate growth of an intact 1T′-WS₂ monolayer without structural defects on the Au surface to construct the conformal interface is quite challenging due to the large lattice mismatch between 1T′-WS₂ and Au. Hence, a detailed inspection was carried out at the interface between 1T′-WS₂ and 4H—Au to reveal its atomic structure and growth relationship (FIG. 2e). Impressively, the integrated pixel intensity profile (FIG. 2f) shows that the distance of ten adjacent W atoms in the 1T′-WS₂ is 2.498 nm, which is approximately equivalent to that of twelve adjacent Au atoms in the 4H—Au (2.502 nm). In other words, if “ABCB” is used to denote the stacking sequence of a unit cell of the 4H phase along the [001]₄H direction, a repeating unit of five 1T′-WS₂ unit cells is corresponding to three 4H—Au unit cells.

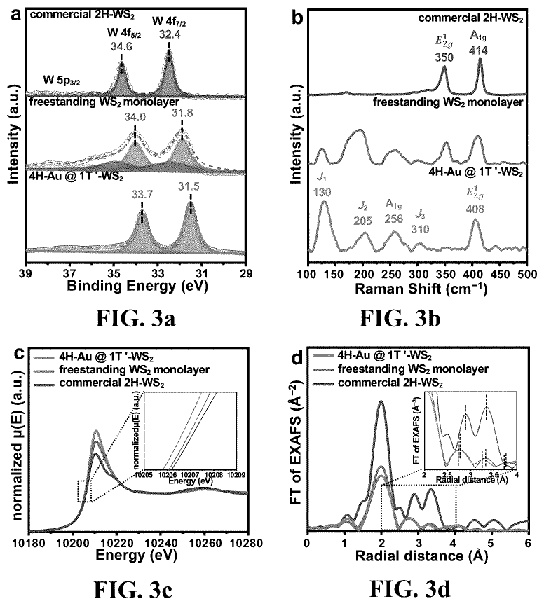

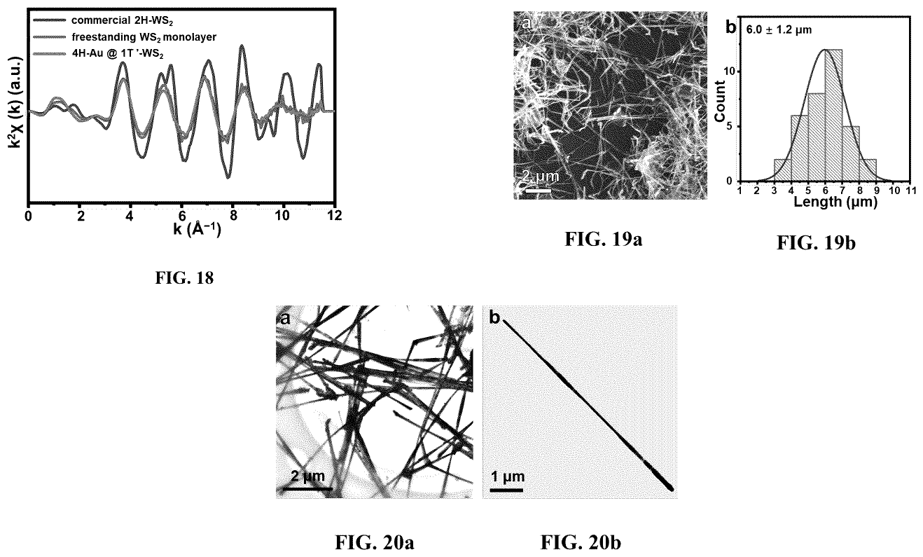

Furthermore, XPS, Raman spectroscopy, XANES and EXAFS were used to characterize the crystal phase of the as-synthesized WS₂ monolayers on 4H—Au, the freestanding WS₂ monolayers (FIG. 17) synthesized by the same wet-chemical method without 4H—Au substrates, and the commercial WS₂ crystals. In the XPS spectrum of 4H—Au@1T′-WS₂ (FIG. 3a), two characteristic peaks located at 33.7 eV and 31.5 eV are assigned to the W 4f_{5/2} and W 4f_{7/2} orbitals of 1T′-WS₂, respectively. Both of them shift to lower binding energy by ˜0.9 eV in comparison with the W 4f_{5/2} (34.6 eV) and W 4f₇/2 (32.4 eV) of 2H—WS₂. Impressively, the binding energies of W 4f in 4H—Au@1T′-WS₂ is negatively shifted by ˜0.3 eV in comparison with the freestanding WS₂ monolayers, corroborating the electron transfer from 4H—Au to WS₂. Furthermore, as demonstrated in FIG. 3b, the Raman spectrum of the as-prepared 4H—Au@1T′-WS₂ shows five distinctive peaks located at 130 cm⁻¹ (J₁), 205 cm⁻¹ (J₂), 256 cm⁻¹ (A_{1g}), 310 cm⁻¹ (J₃) and 408 cm⁻¹ (E¹_{2g}), respectively, similar with the reported results of 1T′-WS₂ nanosheets. The Raman characteristic peaks of 1T′-WS₂ monolayers on 4H—Au are completely different from those of 2H—WS₂ (350 cm⁻¹ (E¹_{2g}) and 414 cm⁻¹ (A_{1g})), confirming the successful growth of high-phase-purity 1T′-WS₂ on 4H—Au. Additionally, X-ray absorption fine structure measurements were combined to investigate the electronic structure and coordination environment of WS₂. The W L₃-edge XANES spectra exhibit that the edge position of 1T′-WS₂ monolayers on 4H—Au shifts to lower energy compared with that of commercial 2H—WS₂, implying that the valence state of W is lower in 1T′-WS₂ than in 2H—WS₂ (FIG. 3c). The FT-EXAFS spectra are provided to reveal the local structure of W in WS₂ (FIG. 3d). Different from the 2H—WS₂ with the nearest W—W distance of 3.18 Å, the distribution of adjacent W—W distances in 1T′-WS₂ monolayers on 4H—Au could be split into three different values, including 2.75, 3.26, and 3.72 Å, in good accordance with the recently reported results obtained from single-crystal XRD (SCXRD). The difference in k²-weighted EXAFS oscillations between 1T′-WS₂ on 4H—Au and 2H—WS₂ also corroborates the structural difference between 1T′ and 2H phases (FIG. 18). The XPS, Raman spectroscopy, XANES, and EXAFS results corroborate that the freestanding WS₂ monolayers in the absence of 4H—Au substrates possess a mixed phase of 2H and 1T′, whereas the crystal phase of the WS₂ monolayers grown on 4H—Au is pure 1T′. These results indicate that 4H—Au plays a unique and imperative role in purifying and stabilizing the metastable 1T′ phase of WS₂ monolayers. In addition, based on the aforementioned wet-chemical synthetic method, we also prepared the 4H—Au@1T′-WSe₂, 4H—Au@ 1T′-MoSe₂, and 4H—Au@1T′-MoS₂.

Growth Mechanism of 1T′-TMD Monolayers on 4H—Au.

To understand the growth mechanism of single-layer 1T′-TMDs on 4H—Au, time-dependent experiments were conducted at intervals of 30 s, and the intermediate stages were characterized by ABF-STEM. Taking 1T′-WS₂ as an example, first, a layer of sulfur atoms is adsorbed tightly to the surface of 4H—Au due to the strong chemical affinity between Au and S atoms²⁸. As known, the concave and convex surfaces of 4H—Au could serve as the preferred nucleation sites of WS₂, and the [WS₂]⁻ nuclei are thereby formed on the zig-zag surface of 4H—Au through the reaction of (NH₄)₂WO₄ and sulfur powder at the nucleation temperature of 290° C. Afterwards, a single-layer WS₂ is synthesized with the assistance of the strong surface ligand, i.e., oleylamine, and then stabilized by the strong interfacial interaction between WS₂ and 4H—Au.

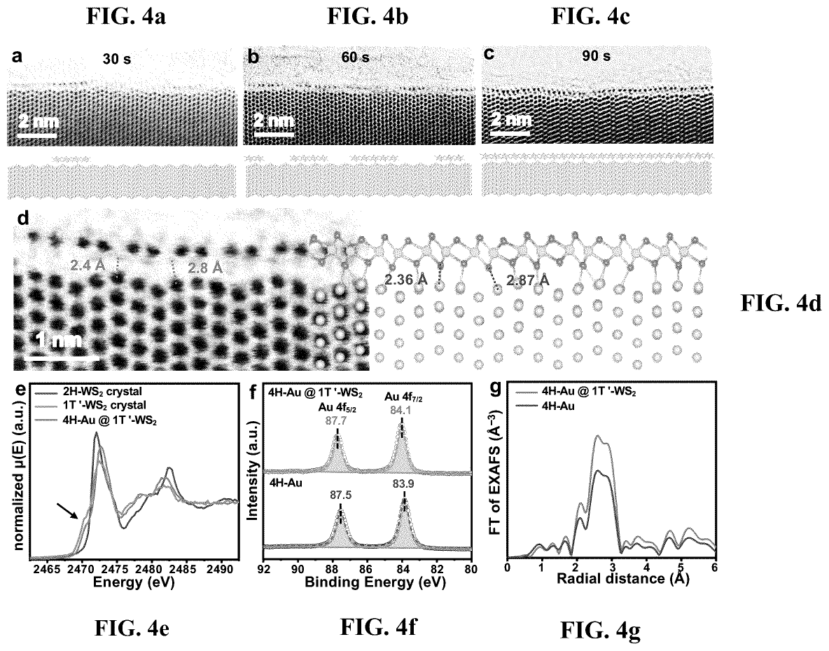

As discussed above, the 4H—Au donates electrons to the WS₂ monolayer, resulting in the phase transformation from 2H to 1T′. As shown in FIG. 4a, a small WS₂ domain with a structure of 1T′ phase first appears on the rough surface of 4H—Au at the reaction time of 30 s. When the reaction time goes to 60 s, abundant 1T′-WS₂ domains are formed on the 4H—Au surface via an island-like growth (FIG. 4b), and finally the 1T′-WS₂ domains merge seamlessly to form a high-quality 1T′-WS₂ monolayer in 90 s (FIG. 4c). Additionally, the atomic-resolution ABF-STEM image and the simulated model are used to investigate the interface between the 1T′-WS₂ monolayer and 4H—Au (FIG. 4d). There are two types of contacts at the interface between Au and TMDs, including vdW and covalent contacts. The minimum interatomic distance between a sulfur atom in the bottom of the sulfur layer of 1T′-WS₂ and a gold atom in the topmost 4H—Au layer is ˜2.4 Å (in good agreement with the simulated result (2.36 Å)), which is close to the covalent Au—S bond length (˜2.42 Å)⁴². The interfacial spacing distance along the unique zig-zag interface between 4H—Au and 1T′-WS₂ is ranged from 2.4 Å to 2.8 Å, shorter than the reported interfacial spacing distance of vdW contact between 2H-TMD monolayer and the topmost gold layer (normally over 3 Å).

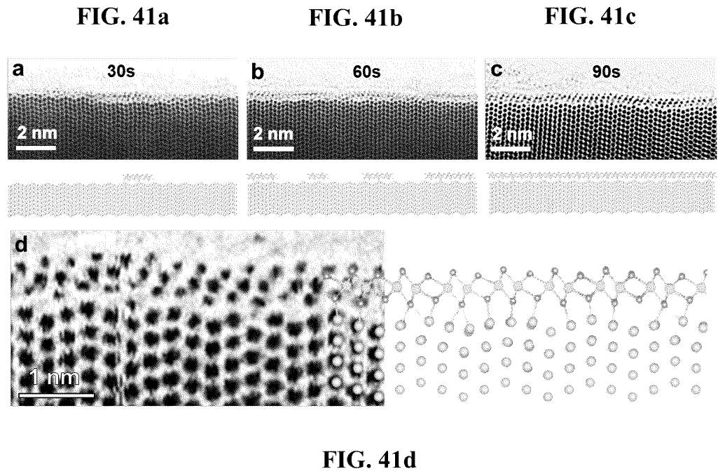

The shorter interfacial spacing distance is a typical signal of the orbital overlapping between the bottom layers of sulfur atoms and the topmost gold atoms, indicating the formation of covalent Au—S bonds. Then the normalized XANES at the sulfur K-edge were used to investigate the interfacial interaction between 4H—Au and 1T′-WS₂ (FIG. 4e). The extra shoulder peak at ˜2470 eV is the characteristic peak of metastable 1T′-WS₂, which can be observed in both 4H—Au@ 1T′-WS₂ and the 1T′-WS₂ crystal. As known, 1T′-WS₂ exhibits lower sulfur K-edge energy compared with that of 2H—WS₂. However, the sulfur K-edge energy in 4H—Au@ 1T′-WS₂ is anomalously higher than that of 1T′-WS₂ crystal, indicating that the electronic structure of 1T′-WS₂ may be largely modified due to the strong covalent Au—S interfacial interaction. In addition, a similar growth mechanism of 1T′-WSe₂ monolayers is observed on 4H—Au (FIG. 41).

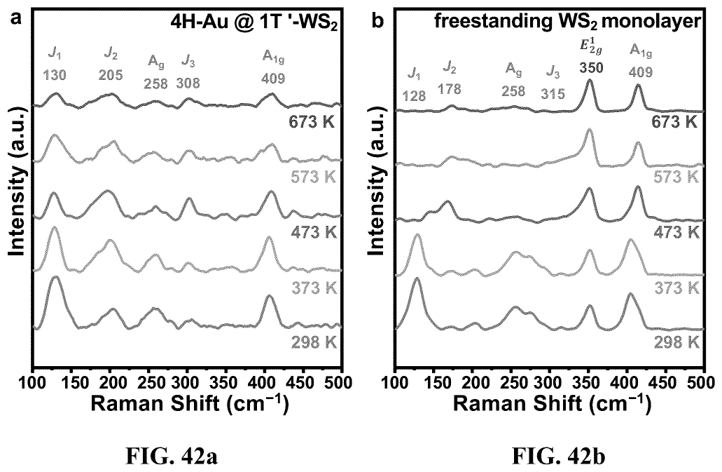

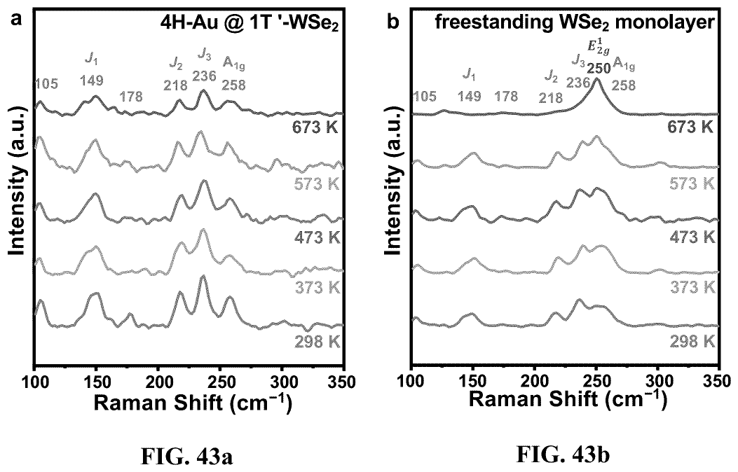

The strong covalent Au—S/Se interfacial interaction also plays a significant role in the stabilization of metastable 1T′-TMDs. Taking WS₂ as an example, specifically, the 4H—Au@ 1T′-WS₂ and the freestanding WS₂ monolayer were annealed at 298 K, 373 K, 473 K, 573 K, and 673 K for 30 min, respectively (FIG. 42). Results of the Raman spectroscopy confirm that with the increase in annealing temperature, the WS₂ monolayer on 4H—Au still maintains the 1T′ phase, whereas the freestanding WS₂ monolayer without 4H—Au substrates undergoes a phase transition from 1T′ to 2H, and completely converts into 2H phase at 673 K, suggesting the superior crystal-phase stability of 1T′-WS₂ on 4H—Au. Likewise, the 4H—Au@ 1T′-WSe₂ also exhibits better crystal-phase stability than that of freestanding WSe₂ monolayers without 4H—Au substrates during annealing (FIG. 43).

To date, mostly reported single-layer TMDs on Au substrates possess a 2H phase or a mixed phase of 2H and 1T′. For example, CVD is a well-developed method to synthesize high-quality 2H-TMD monolayers on the Au surface. Normally, the participation of vapored sulfur during the relatively high-temperature CVD growth of 2H—MoS₂ and WS₂ could often result in the vdW interfacial reconstruction of the Au surface i.e., the formation of a metastable Au₄S₄ superstructure on the topmost surface of Au, and thereby enhanced the vdW interfacial interaction between Au and as-grown 2H-TMDs. As shown in the atomic-resolution ABF-STEM image (FIG. 4d), the above-mentioned gold sulfides at the interface between 1T′-WS₂ and 4H—Au was not observed. As shown in the Au 4f XPS spectra in FIG. 4f, the 4H—Au in 4H—Au@ 1T′-WS₂ still remains metallic after the growth of 1T′-WS₂ monolayer. Compared to pure 4H—Au, a slight red shift can be observed in both Au 4f_{5/2} and 4f_{7/2} peaks of 4H—Au@ 1T′-WS₂, indicating the interfacial electron transfer from 4H—Au to 1T′-WS₂. To further confirm this transfer, FT-EXAFS is provided to investigate the local structure of Au in 4H—Au@ 1T′-WS₂ (FIG. 4g). The peak shape and bond length of the Au—Au in 4H—Au@ 1T′-WS₂ in R space are similar to those of 4H—Au, indicating that the 4H—Au is still in the metallic state without the formation of gold sulfides after the growth of 1T′-WS₂. All the evidence demonstrated that the low-temperature and rapid wet-chemical method of the present invention maintains a clean interface between 1T′-WS₂ and 4H—Au. Therefore, 4H—Au directly induces a 2H to 1T′ phase transformation of WS₂ monolayer through the strong covalent Au—S interaction at the clean interface between 1T′-TMD and 4H—Au as well as the interfacial electron transfer from 4H—Au to 1T′-WS₂.

WSe₂ on Au

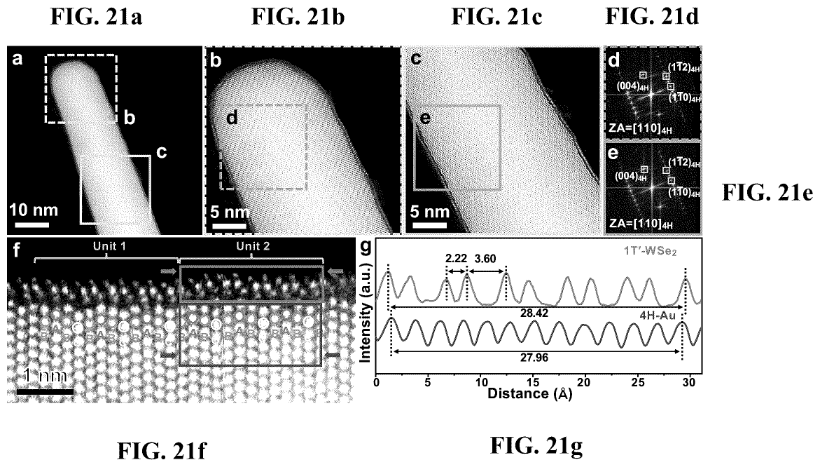

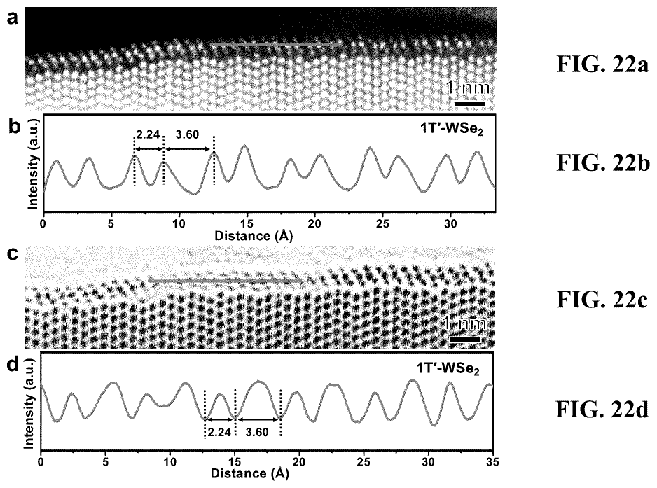

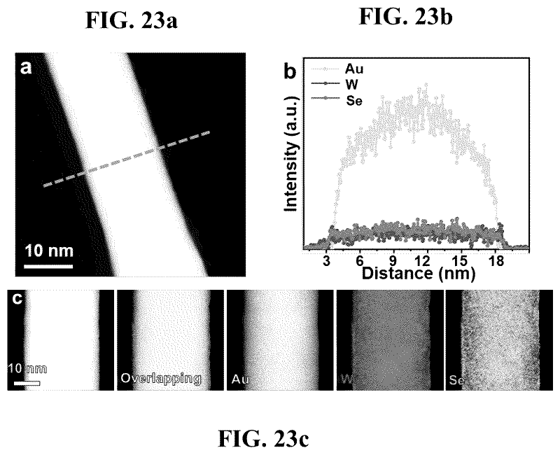

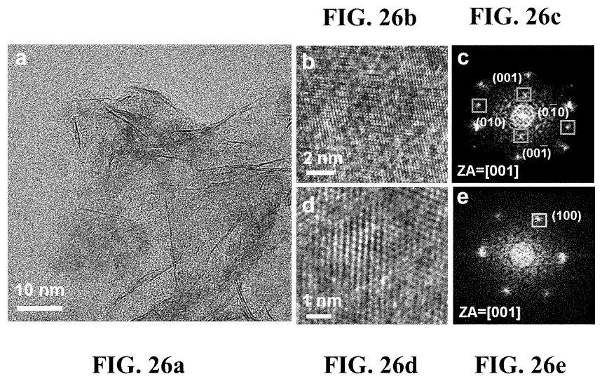

4H—Au@1T′-WSe₂ was also synthesized as described above and fully characterized. Similarly, the as-prepared 4H—Au@1T′-WSe₂ displays an average length of 6.0±1.2 μm, depicted in the SEM image (FIG. 19) and TEM images (FIG. 20). The HAADF-STEM images obtained from the end part (FIG. 21b) and side part (FIG. 21c) of a typical 4H—Au@ 1T′-WSe₂ (FIG. 21a) are used to further investigate the growth models of the 1T′-WSe₂ monolayers on 4H—Au. Likewise, the as-prepared 1T′-WSe₂ achieves an intact conformal encapsulation growth at not only the side parts but also the end parts of the 4H—Au which possess higher strain originating from the extreme curvature. The intimate core-shell interface constructed by conformal encapsulation maximizes the interfacial interaction between 1T′-WSe₂ and 4H—Au³⁰. Moreover, the HAADF-STEM images (FIG. 21b, 21c) and the corresponding FFT patterns (FIG. 21d, 21e) substantiate that the Au NW maintains the pure 4H phase during the growth of 1T′-WSe₂. The atomic-resolution HAADF-STEM (FIG. 22a) and ABF-STEM (FIG. 22c) images confirm that a single layer of W atoms in the WSe₂ monolayer is located on the surface of a 4H—Au, and the corresponding intensity profiles ((FIG. 22b, 22d) corroborate that the short and long W—W distances are ˜0.22 and 0.36 nm, respectively, in good agreement with those of the 1T′-WSe₂ monolayer crystal model (0.2255 nm and 0.3692 nm) observed from the side view. In specific, a repeating unit of five 1T′-WSe₂ unit cells equivalent to three 4H—Au unit cells along the [001]₄H direction may explain the conformal encapsulation growth of the 1T′-WSe₂ monolayer on the surface of 4H—Au. The STEM-EDS line scanning profiles (FIG. 23a, 23b) and the STEM-EDS element mappings (FIG. 23c) confirm the uniform distribution of Au, W, and Se in the 4H—Au@ 1T′-WSe₂, indicating the even growth of 1T′-WSe₂ on the Au NW. The freestanding WSe₂ monolayers in the absence of 4H—Au substrates were also synthesized. The HRTEM image and the corresponding FFT patterns of two different areas in the freestanding WSe₂ monolayers confirm that the as-prepared WSe₂ monolayers possess a mixed phase of 1T′ and 2H (FIG. 26).

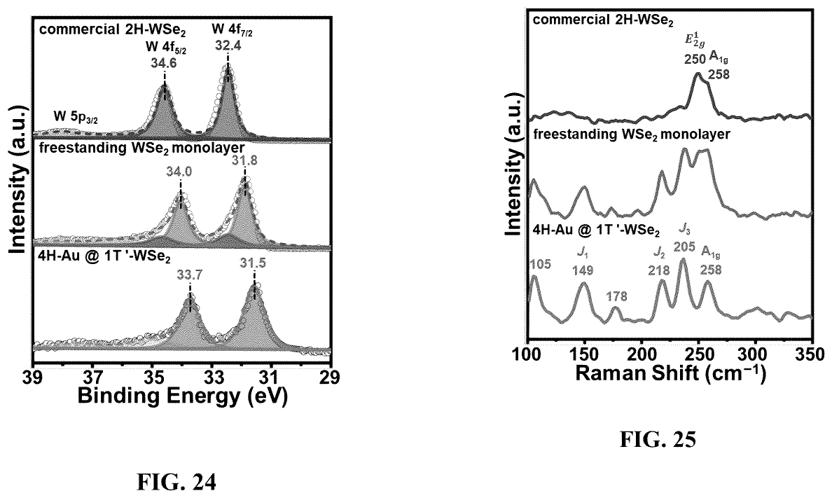

Similarly, XPS and Raman spectroscopy were used to characterize the crystal phase of the as-synthesized WSe₂ monolayers on 4H—Au, the as-prepared freestanding WSe₂ monolayers, and the commercial WSe₂ crystals. As shown in the XPS spectra in FIG. 24, the W 4f peaks of 1T′-WSe₂ located at 33.7 eV and 31.5 eV can be attributed to 4f_{5/2} and 4f_{7/2}, respectively. The 1T′ phase characteristic peaks exhibit a clear shift of ˜0.9 eV in comparison with those of 2H—WSe₂ (34.6 eV and 32.4 eV). By comparing the XPS spectra of 4H—Au@ 1T′-WSe₂ with freestanding WSe₂ monolayers, a similar electron transfer from 4H—Au to 1T′-WSe₂ can also be deduced. Furthermore, the Raman spectrum of 4H—Au@ 1T′-WSe₂ is presented in FIG. 25, the Raman peaks at 149 cm⁻¹ (J₁), 218 cm⁻¹ (J₂), and 236 cm⁻¹ (J₃) are characteristic vibrational modes of 1T′-WSe₂, whereas the typical Raman active modes of in-plane E¹_{2g} peak (250 cm⁻¹) and out-of-plane A_{1g} (258 cm⁻¹) belonging to the 2H—WSe₂ are absent in the Raman spectrum of 4H—Au@1T′-WSe₂, indicating the high purity of the 1T′ phase. The peaks located at 105 cm⁻¹, 149 cm⁻¹, 178 cm⁻¹, 218 cm⁻¹, 236 cm⁻¹, and 258 cm⁻¹ are similar to the reported results of 1T′-WSe₂ nanoflowers, suggesting the formation of high-phase-purity 1T′-WSe₂ monolayer on 4H—Au (FIG. 17).

MoS₂ on Au

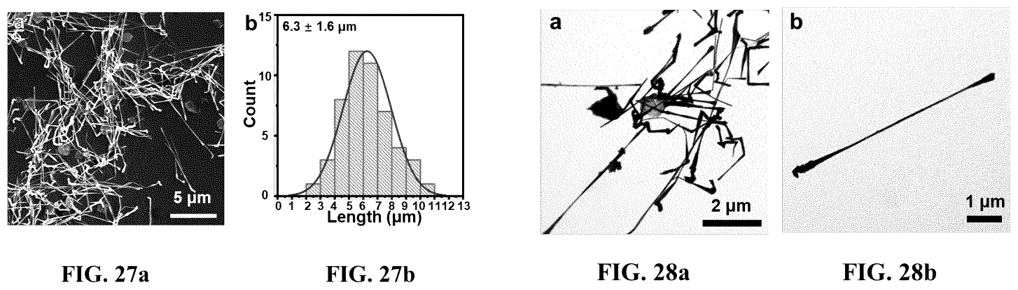

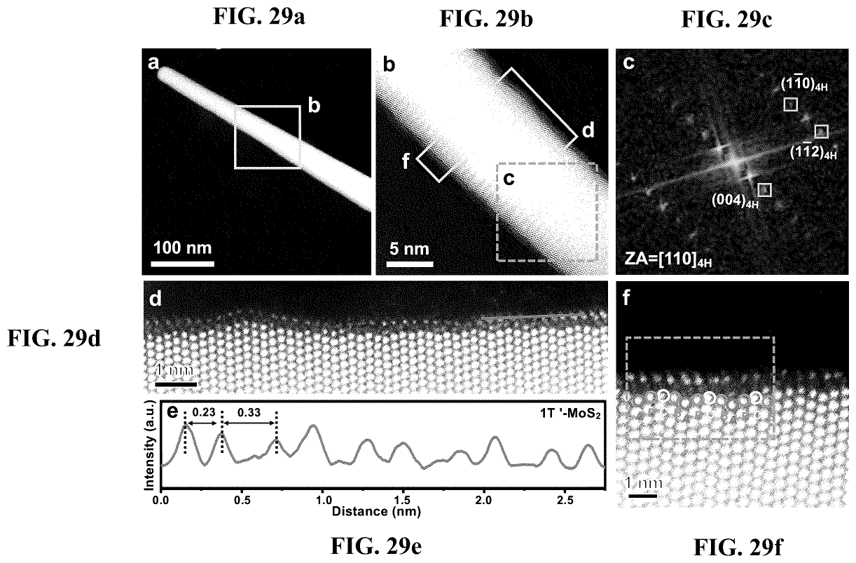

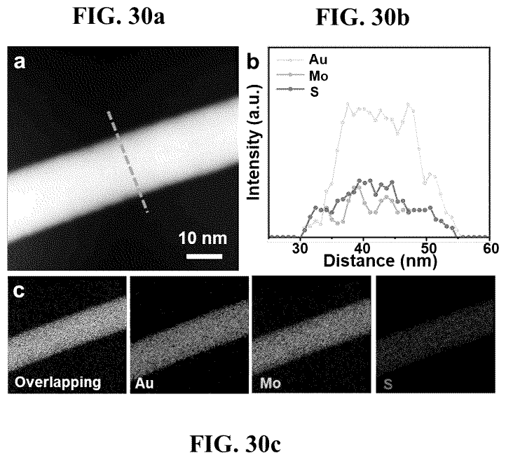

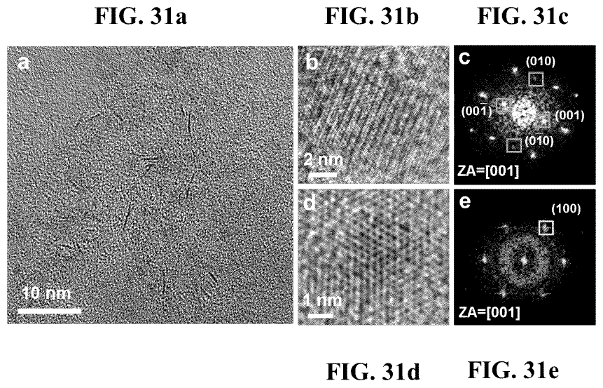

4H—Au@1T′-MoS₂ was also synthesized as described above and fully characterized. The average length of 4H—Au@1T′-MoS₂ is 6.3±1.6 μm, which is in good agreement with other 4H—Au@1T′-TMDs, as shown in the SEM (FIG. 27) and TEM images (FIG. 28). Similarly, the HAADF-STEM images display the uniform formation of MoS₂ on the surface of a 4H—Au (FIG. 29a, 29b). After the growth of 1T′-MoS₂, the Au NW remains in the 4H phase, confirmed by the HAADF-STEM image (FIG. 29b) and the corresponding FFT pattern (FIG. 29c). Likewise, a single layer of MoS₂ with two different Mo—Mo distances of ˜0.23 nm and 0.33 nm can be observed in the atomic-resolution HAADF-STEM image (FIG. 29d) and the corresponding intensity profile (FIG. 29e), indicating the formation of a distorted 1T′-MoS₂ monolayer on 4H—Au. Moreover, the growth of the 1T′-MoS₂ monolayer also follows the growth relationship that a repeating unit of five 1T′-MoS₂ unit cells corresponding to three 4H—Au unit cells (FIG. 29f). The STEM-EDS line scanning profiles (FIG. 30a, 30b) and the STEM-EDS element mappings (FIG. 30c) corroborate the uniform distribution of Au, Mo, and S elements and the formation of MoS₂ on the surface of Au NWs. As a comparison sample, freestanding MoS₂ monolayers were also prepared in the absence of 4H—Au substrates. The HRTEM image and the corresponding FFT patterns of two different areas in the freestanding MoS₂ monolayers demonstrate that the as-prepared MoS₂ monolayers possess a mixed phase of 1T′ and 2H (FIG. 31).

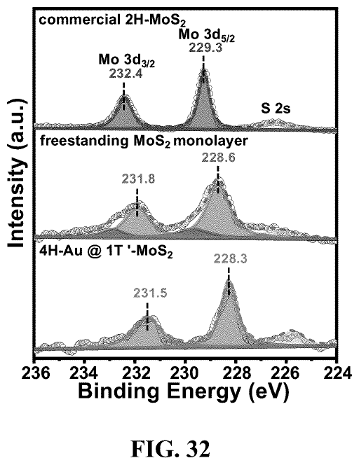

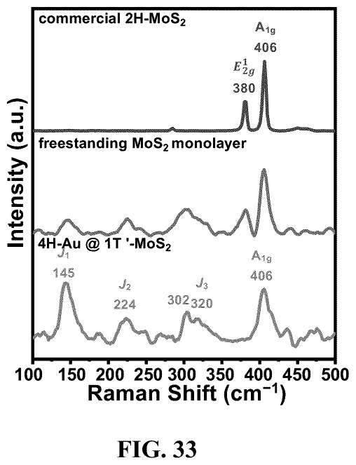

XPS and Raman spectroscopy were used to characterize the crystal phase of the as-synthesized MoS₂ monolayers on 4H—Au, the as-prepared freestanding MoS₂ monolayers, and the commercial MoS₂ crystals. As shown in the XPS spectrum of 4H—Au@1T′-MoS₂ (FIG. 32), two characteristic peaks located at 231.5 eV and 228.3 eV are attributed to the Mo 3d_{3/2} and Mo 3d_{5/2} orbitals of 1T′-MoS₂, respectively. Both of them shift to lower binding energy by ˜0.9 eV in comparison with the Mo 3d_{3/2} (232.4 eV) and Mo 3d_{5/2} (229.3 eV) of 2H—MoS₂. In comparison with freestanding MoS₂ monolayers, the binding energy of Mo 3d in 4H—Au@1T′-MoS₂ is negatively shifted by ˜0.3 eV implying a similar electron transfer from 4H—Au to the MoS₂ monolayers. Additionally, the Raman spectrum of the as-prepared 4H—Au@1T′-MoS₂ (FIG. 33) displays five distinctive peaks located at 145 cm⁻¹ (J₁), 224 cm⁻¹ (J₂), 302 cm⁻¹, 320 cm⁻¹ (J₃) and 406 cm⁻¹ (A_{1g}), respectively, which are in good agreement with those of the reported 1T′-MoS₂ monolayers. The Raman peaks of 1T′-MoS₂ on 4H—Au are completely different from those of 2H—MoS₂ (380 cm⁻¹ (E¹_{2g}) and 406 cm⁻¹ (A_{1g})), demonstrating the formation of high-phase-purity 1T′-MoS₂ monolayer on 4H—Au.

MoSe₂ on Au

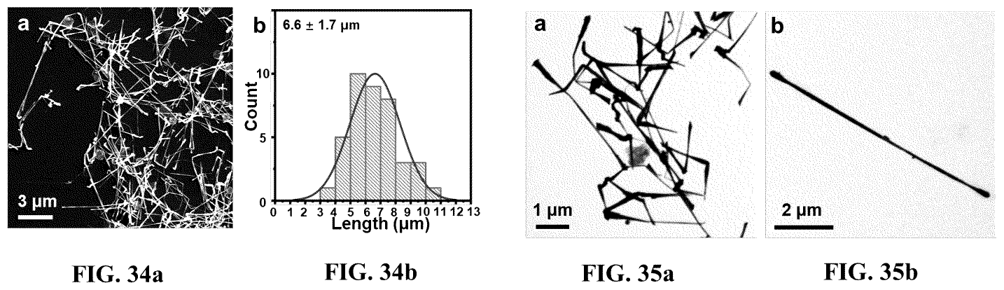

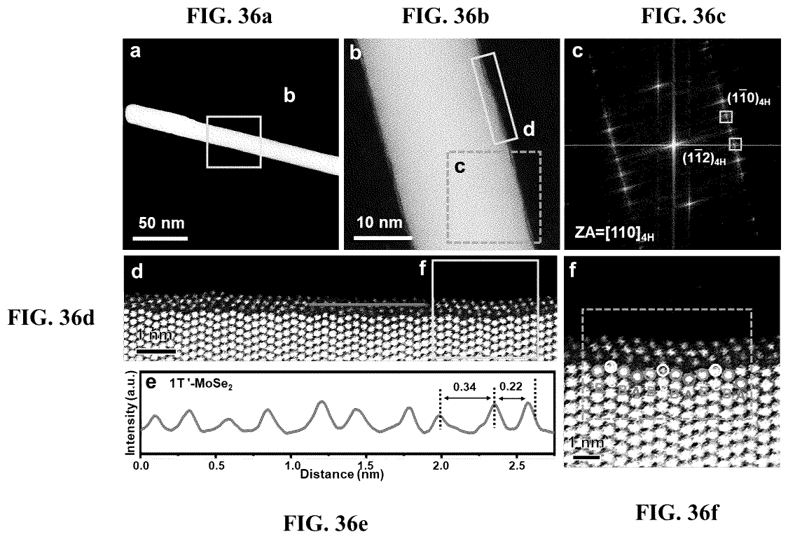

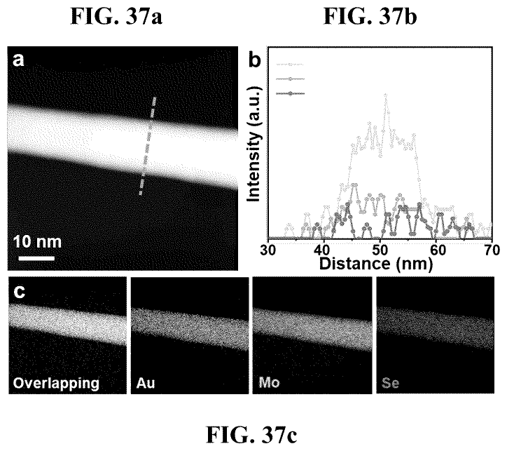

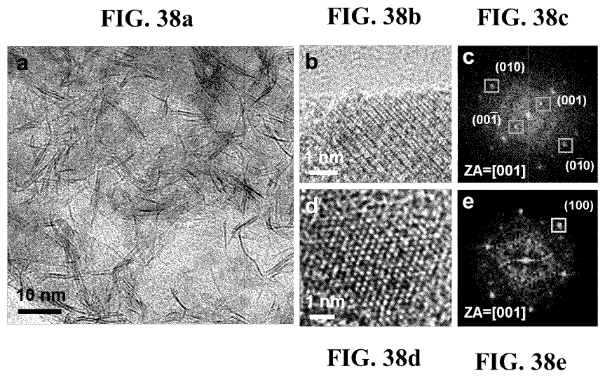

In addition, 4H—Au@1T′-MoSe₂ was also synthesized as described above and fully characterized. As shown in the SEM (FIG. 34) and TEM images (FIG. 35), the as-prepared 4H—Au@1T′-MoSe₂ NWs exhibit an average length of 6.6±1.7 μm, similar to the morphology of other 4H—Au@1T′-TMDs. Likewise, a single layer of MoSe₂ is closely coated on the surface of a 4H Au, confirmed by the HAADF-STEM images (FIG. 36a, 36b). Moreover, the HAADF-STEM image (FIG. 36b) and the corresponding FFT pattern (FIG. 36c) show that the Au NW still maintains the 4H phase after the growth of 1T′-MoSe₂. The atomic-resolution HAADF-STEM image (FIG. 36d) and the corresponding intensity profile (FIG. 36e) exhibit two different Mo—Mo distances of ˜0.22 nm and 0.34 nm, suggesting the formation of a distorted 1T′-MoSe₂ monolayer on 4H—Au. Furthermore, the growth of single-layer 1T′-MoSe₂ also follows the growth relationship that a repeating unit of five 1T′-MoSe₂ unit cells corresponding to three 4H—Au unit cells (FIG. 36f). The STEM-EDS line scanning profiles (FIG. 37a, 37b) and the STEM-EDS element mappings (FIG. 37c) demonstrate the uniform distribution of Au, Mo, and Se elements and the core-shell structure formed by the growth of MoSe₂ on the surface of 4H—Au. Freestanding MoSe₂ monolayers in the absence of 4H—Au substrates was also synthesized. The HRTEM image and the corresponding FFT patterns of two different areas in the freestanding MoSe₂ monolayers confirm that the as-prepared MoSe₂ monolayers possess a mixed phase of 1T′ and 2H (FIG. 38).

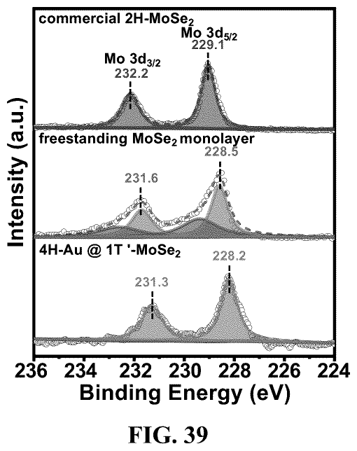

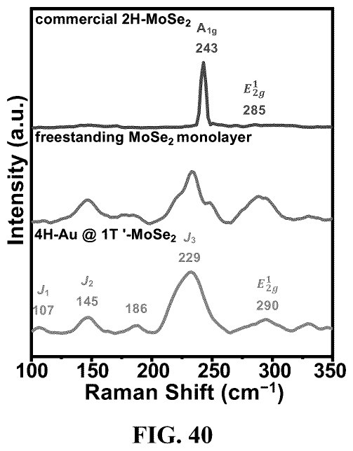

XPS and Raman spectroscopy were used to characterize the crystal phase of the as-synthesized MoSe₂ monolayers on 4H—Au, the as-prepared freestanding MoSe₂ monolayers, and the commercial MoSe₂ crystals. In the XPS spectrum of 4H—Au@1T′-MoSe₂ (FIG. 39), two characteristic peaks located at 231.3 eV and 228.2 eV, assigned to the Mo 3d_{3/2} and Mo 3d_{5/2} orbitals of 1T′-MoSe₂, respectively. Both of them shift to lower binding energy by ˜0.9 eV compared with the Mo 3d_{3/2} (232.2 eV) and Mo 3d_{5/2} (229.1 eV) of 2H—MoSe₂. The binding energy of Mo 3d in 4H—Au@1T′-MoSe₂ is negatively shifted by ˜0.3 eV compared with freestanding MoSe₂ monolayers, indicating the similar electron transfer from 4H—Au to the single-layer MoSe₂. Additionally, the Raman spectrum of the as-prepared 4H—Au@1T′-MoSe₂ (FIG. 40) shows five distinctive peaks located at 107 cm⁻¹ (J₁), 145 cm⁻¹ (J₂), 186 cm⁻¹, 229 cm⁻¹ (J₃) and 290 cm⁻¹ (E¹_{2g}), respectively, which are completely different from those of 2H—MoSe₂ (243 cm⁻¹ (E¹_{2g}) and 285 cm⁻¹ (A_{1g})), confirming the successful growth of single-layer 1T′-MoSe₂ on 4H—Au.

1T′-TMDs on Other Metal Nanomaterials

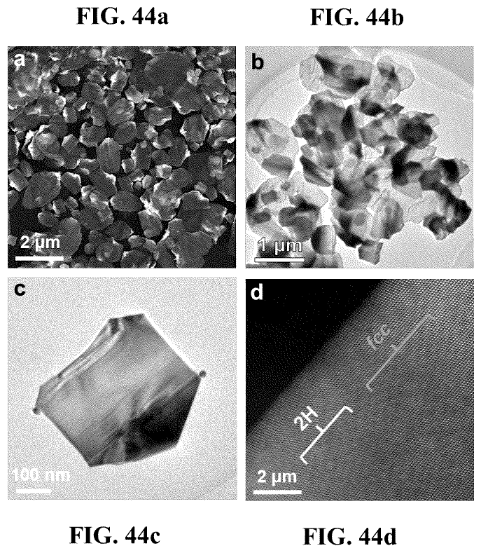

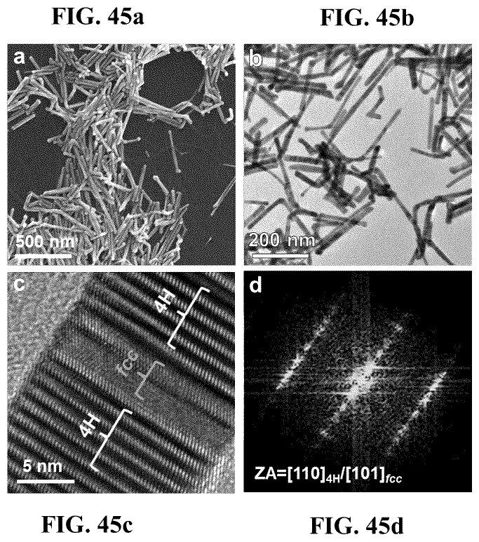

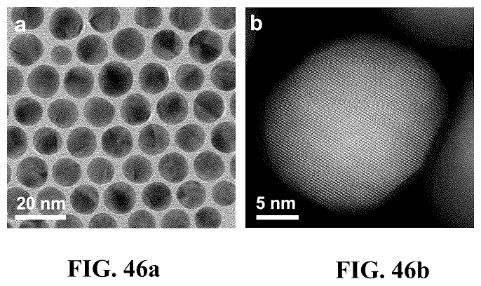

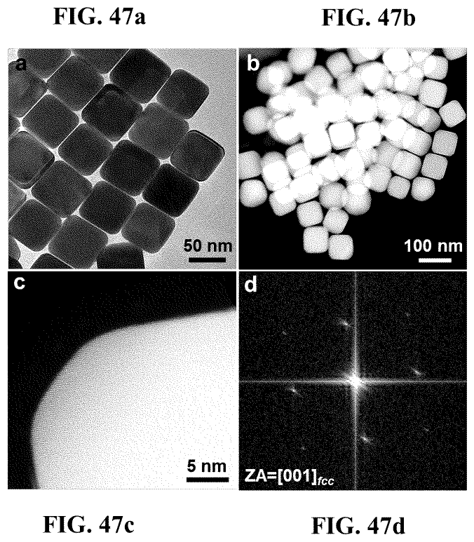

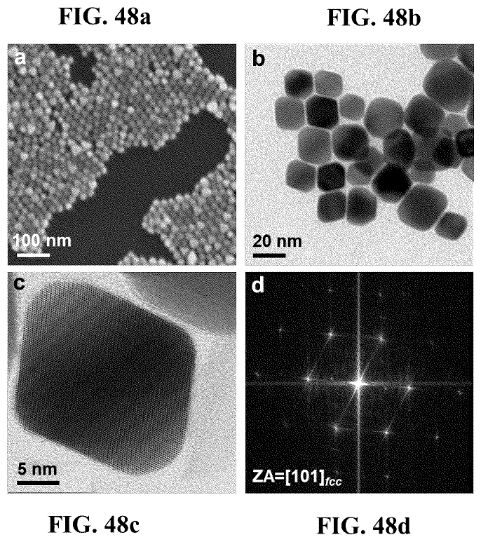

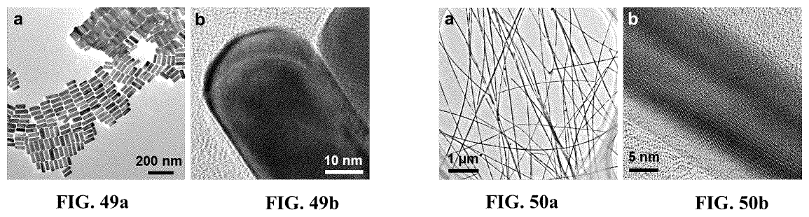

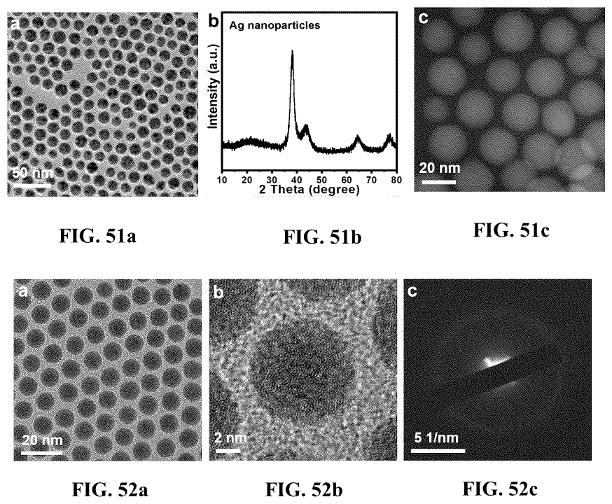

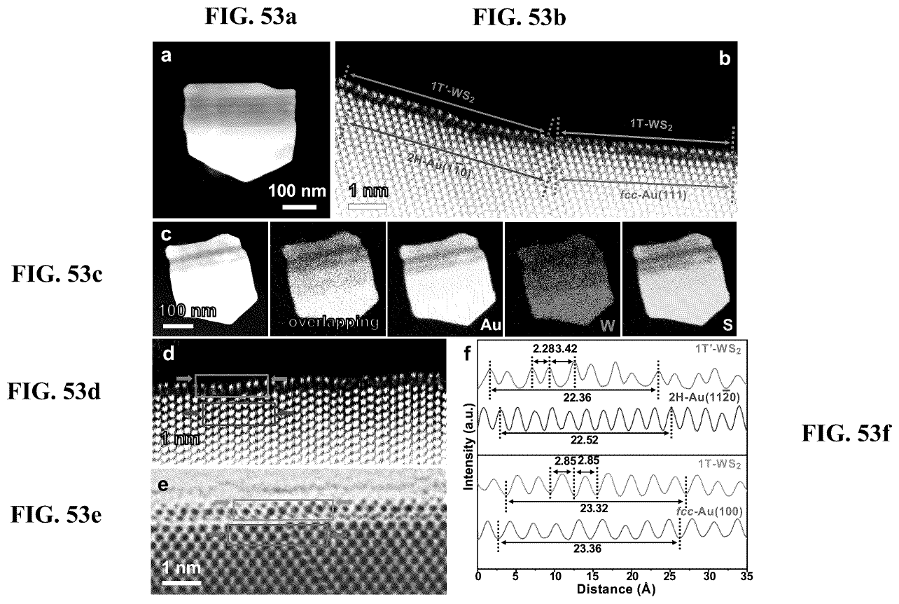

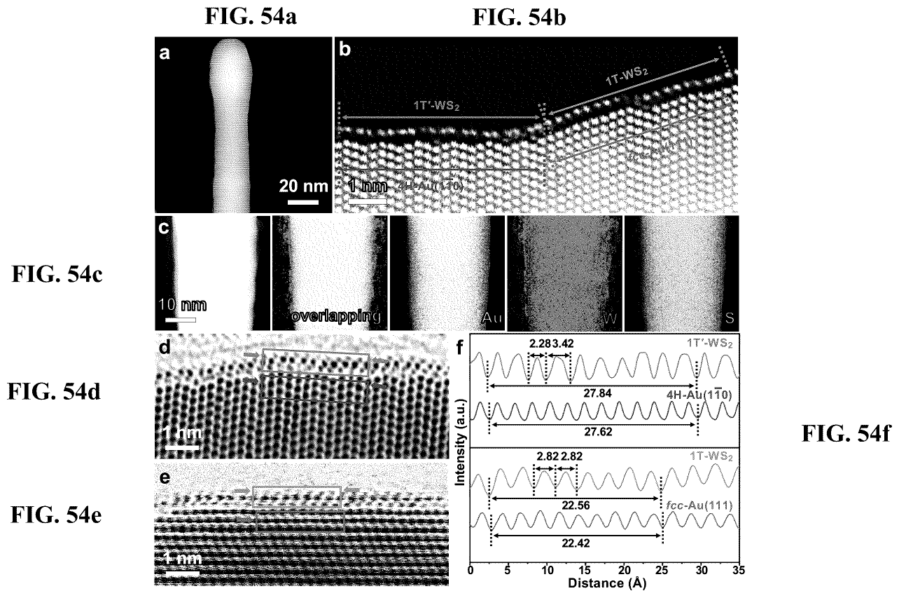

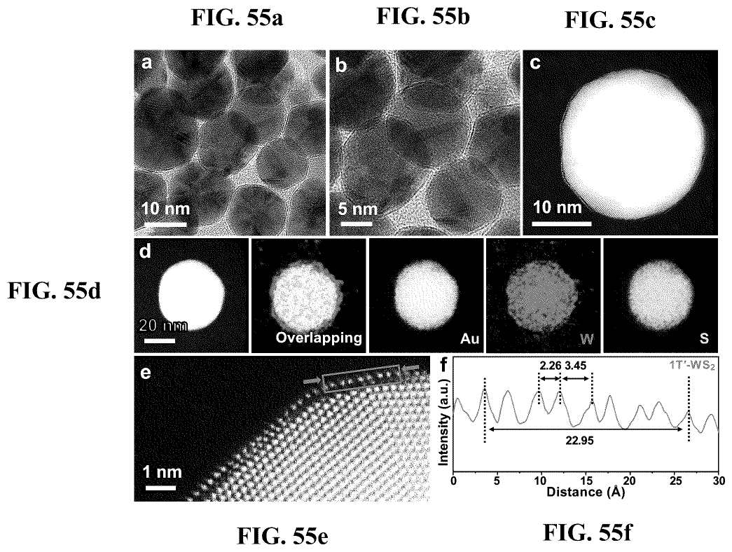

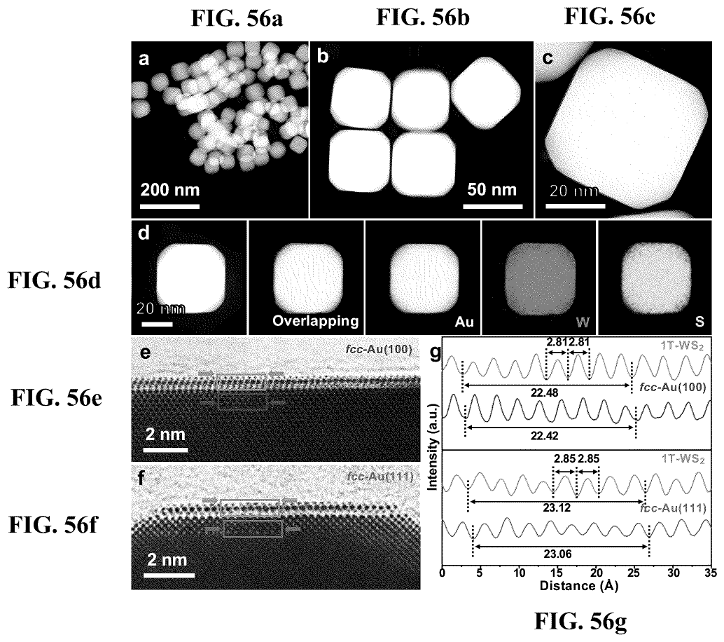

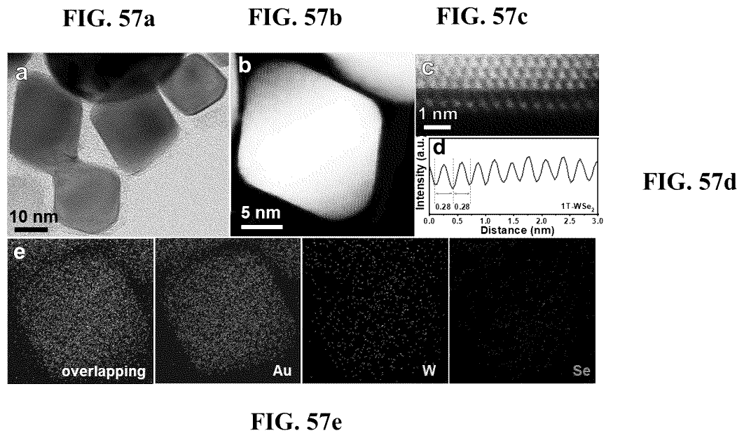

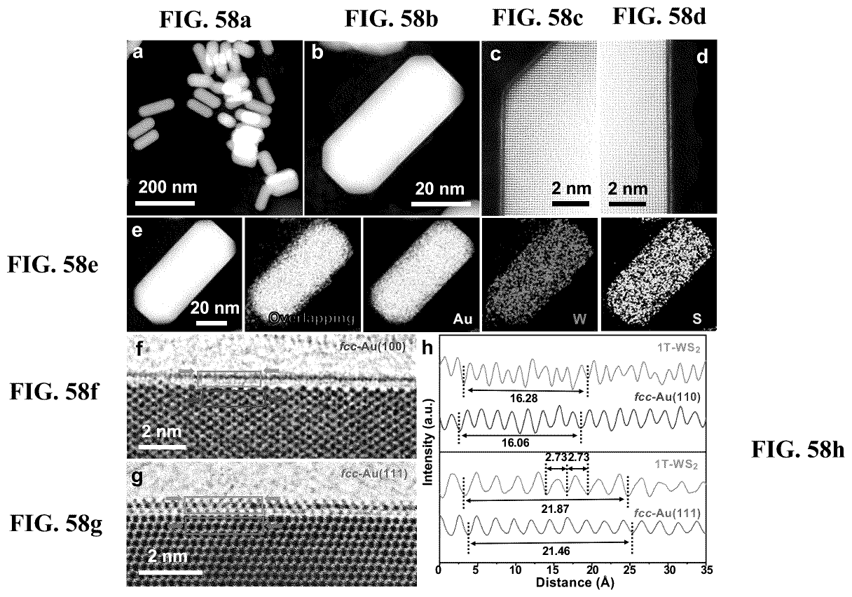

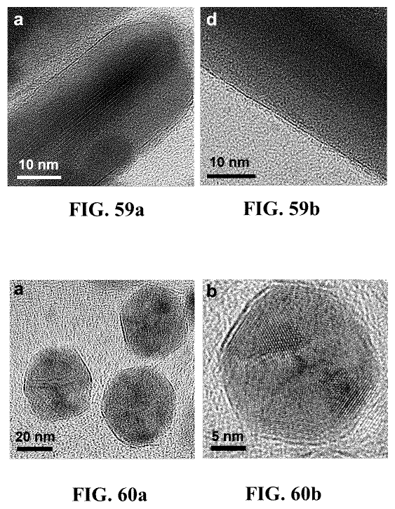

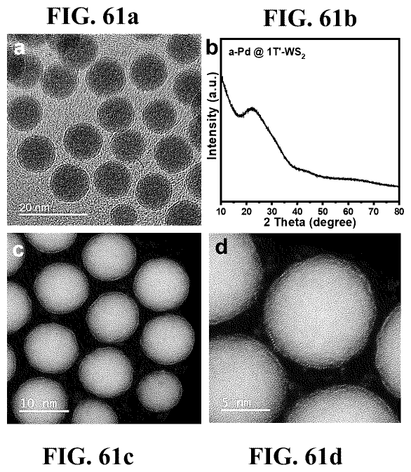

Besides 4H—Au NWs, other metal nanomaterials, including 2H/fcc-Au nanosheets (FIG. 44), 4H/fcc-Au nanorods (FIG. 45), fcc-Au nanoparticles (FIG. 55), fcc-Au nanocubes (FIG. 47), fcc-Au nano-octahedra (FIG. 48), fcc-Au nanorods (FIG. 49), fcc-Ag nanowires (FIG. 55), fcc-Ag nanoparticles (FIG. 51) and amorphous Pd nanoparticles (FIG. 52c) can be used as substrates to grow 1T′-TMDs to prepare 2H/fcc-Au@1T′/1T-WS₂ nanosheets (FIG. 53), 4H/fcc-Au@1T′/1T-WS₂ nanorods (FIG. 54), fcc-Au@1T′-WS₂ nanoparticles (FIG. 55), fcc-Ag@ 1T′-WS₂ nanoparticles (FIG. 60) and amorphous Pd@ 1T′-WS₂ nanoparticles (FIG. 61) in a similar synthetic strategy.

SERS Performance of 4H—Au@1T′-TMDs

SERS measurements. A set of ethanol solutions of dye (R6G, CV, and MG) with various concentrations from 10⁻³ M (mM) to 10⁻¹⁸ M (aM) were prepared by sequential diluting processes. For each Raman measurement, 10 μL of dye solution was dropped on SiO₂/Si substrates covered with the prepared materials (4H—Au@1T′-WS₂, 4H—Au, 1T′-WS₂ monolayer, freestanding 2H/1T′-WS₂ monolayer, and 2H—WS₂ monolayer) followed by a natural drying process. The resultant substrate was then rinsed several times with absolute ethanol to remove the residuals on the surface and dried before Raman measurements. Raman measurements were carried out on a LabRAM HR Evolution Raman spectrometer (Horiba Jobin Yvon). The excitation wavelength is 532 nm, and the laser power was set at 0.1 mW with an exposure time of 40 s unless specified. Raman spectra of dyes were treated with baseline correction for a better comparison of their Raman enhancement effect.

Calculations of EFs.

EFs were calculated according to the following equation:

EF=(I_{SERS}/N_{SERS})/(I_{bulk}/N_{bulk})

where I_{SERS} is the Raman intensity of dye molecules for the SERS measurements; I_{bulk} is the Raman intensity of the bulk dye molecules; N_{SERS} is the amount of dye molecules involved in the SERS measurements; N_{bulk}, is the amount of bulk dye molecules for Raman measurement.

Here, as an example, the Raman peak of R6G at 1362 cm⁻¹ is used to calculate EFs. The Raman intensities at 1362 cm⁻¹ of R6G molecules on a single 4H—Au@1T′-WS₂ (1×10⁻¹⁸ M) is 126 counts with an acquisition time of 40 s, respectively. The Raman intensity at 1362 cm⁻¹ of bulk R6G is 94 counts with an acquisition time of 0.4 s.

I_{SERS}/I_{bulk}=(126/40)/(94/0.4)=1.34×10⁻².

In the SERS experiments, 10 μL of dye solution was drop-casted on a SiO₂/Si substrate (0.25 cm²) with the SERS material followed by a gentle dry process.

N_{SERS}=cVN_{A}A₁/A_{sub}, where c is the dye concentration; V is the dye droplet volume; N_{A} is the Avogadro constant; A₁ is the laser spot area; A_{sub} is the substrate area. 0.1 M R6G solution (with sufficient volume) was drop-casted on the bare SiO₂/Si and dried to form bulk R6G powders for calculating N_{bulk}. N_{bulk}=ρhN_{A}A₁/M, where ρ is the density of bulk R6G (1.15 g/cm³); h is the laser penetration depth (21 m); M is the molar mass of R6G (479.02 g/mol). Taking all the above-mentioned factors into account, the EF of a single 4H—Au@1T′-WS₂ for the detection of R6G can be calculated as:

EF=(I_{SERS}/I_{bulk})/(cVM/ρhA_{sub})=(1.34×10⁻²×1.15×21×10⁴×0.25)/(10⁻¹⁸×10×10⁻⁶×479.02)=1.69×10¹⁵.

Preparation of the SARS-CoV-2 S protein solution. The SARS-CoV-2 S protein (Omicron/B.1.1.529 variant) solution was purchased from Sanyou Biopharmaceuticals Co. Ltd. (100 μg/tube) and diluted to 10 mL by adding PBS solution. The predicted molecular weight is 28.19 kDa (≈28190). The SARS-CoV-2 S protein (Wild type) solution was purchased from GeneTex (100 μg/tube) and diluted to 10 mL by adding PBS solution. The predicted molecular weight is 30 kDa (≈30000).

Here, we take the preparation of Omicron variant S protein solution as an example, 2.83 μL of diluted Omicron variant S protein solution was added to 1 mL PBS solution. As for the purchased Omicron variant S protein solution, the numbers of mole (n) and molecules (N) are shown below:

n=m/M=100×10⁻⁻⁶ g/28190=3.54×10⁻⁹ mol

N=n×N_{A}=3.54×10⁻⁹×6.02×10²³=2.13×10¹⁵

As for the diluted Omicron variant S protein solution, the numbers of mole (n₁) and molecules (N₁) are shown below:

N₁=2.13×10¹⁵×2.83/10×10³=6.03×10¹¹

n₁=N₁/N_{A}=6.03×10¹¹/6.02×10²³=1×10⁻¹² mol

The concentration (c) of the mother solution for Omicron variant S protein is shown below:

c=n₁/V₁=1×10⁻¹²/1×10⁻³=1×10⁻⁹ M (nM)

Then the Omicron variant S protein solution was diluted to a variety of concentration from 1×10⁻⁹ M (nM) to 1×10⁻¹⁸ M (aM).

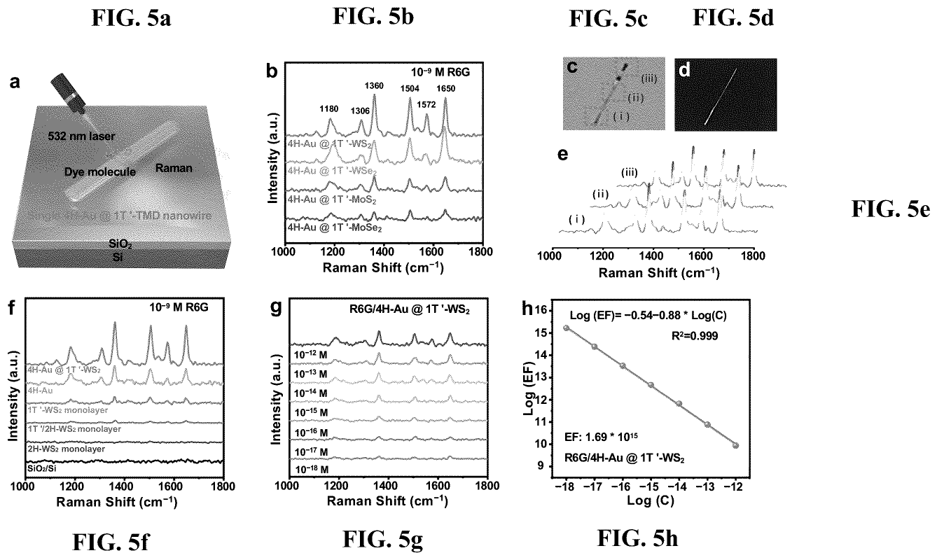

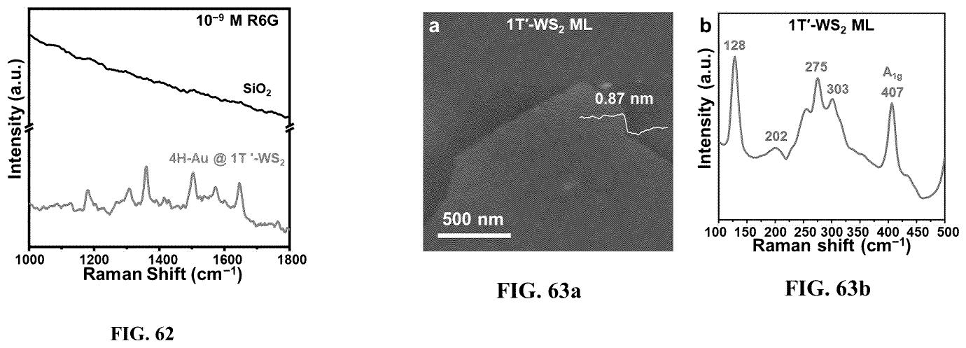

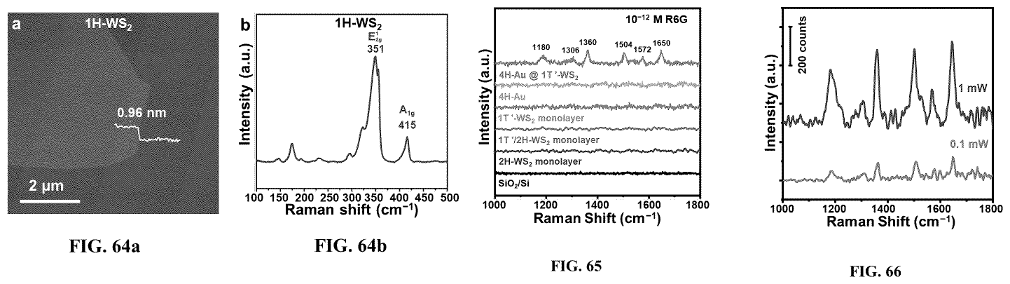

A single 4H—Au@1T′-TMD was used as a SERS-active platform to investigate the intrinsic SERS performance of the 4H—Au@1T′-TMDs through applying a typical dye molecule R6G as the Raman probe. As illustrated in FIG. 5a, the R6G solution with a concentration of 10⁻⁹ M was drop-casted on the surface of a single 4H—Au@1T′-TMD, and the Raman spectra were acquired under an excitation wavelength of 532 nm. To begin with, the intrinsic SERS performance of four different types of the single 4H—Au@1T′-TMD were investigated. As shown in FIG. 5b, the 4H—Au@1T′-WS₂ exhibits the best SERS performance, which is superior to 4H—Au@1T′-WSe₂, 4H—Au@1T′-MoS₂, and 4H—Au@1T′-MoSe₂. Then we selected a single 4H—Au@1T′-WS₂ as a typical representative. The length of the 4H—Au@1T′-WS₂ is around 6 μm, which is larger than the diameter of the laser spot (˜500 nm), as depicted in the optical microscope and SEM images (FIG. 5c, d). Then the SERS signal reproducibility was investigated at different positions on a single 4H—Au@1T′-WS₂. The SERS spectra of R6G taken at three different positions on the same 4H—Au@1T′-WS₂ are practically consistent in intensity and shape, suggesting that the enhanced Raman signals are uniformly distributed on a single 4H—Au@1T′-WS₂. Plasmonic noble metal substrates for SERS suffer from a large analyte fluorescence (FL) background, which is a major obstacle to obtaining the high signal-to-background ratio SERS resonance. The 1T′-WS₂ monolayer on 4H—Au may serve as an ideal analyte fluorescence quencher to exhibit a clean SERS signal due to the consequence of charge transfer and energy transfer between R6G and 1T′-WS₂. In contrast, the signals on the bare SiO₂ substrate form a large FL background of R6G rather than detectable R6G Raman peaks (FIG. 62).

A series of comparative examples were performed to compare the Raman enhancement effects of the 4H—Au@1T′-WS₂ with other materials, including 4H—Au, freestanding 1T′/2H—WS₂ monolayer, as well as 1T′-WS₂ (FIG. 65) and 2H—WS₂ monolayers (FIG. 65) mechanically exfoliated by adhesive tape. FIG. 5c compares the Raman spectra of R6G solution (10⁻⁹ M) deposited on the above-mentioned materials and bare SiO₂. The Raman enhancement of R6G molecules on the 4H—Au@1T′-WS₂ is much stronger than those on the 4H—Au, 1T′-WS₂ monolayer, freestanding 1T′/2H—WS₂ monolayer, and 2H—WS₂ monolayer. Notably, as the ratio of the semiconducting 2H phase in WS₂ increases, the Raman enhancement significantly decreases, which is in good accordance with the reported results. When the R6G concentration goes to a lower one of 10⁻¹² M, it is remarkable that 4H—Au@1T′-WS₂ still performs a highly efficient SERS effect, whereas no Raman signals of R6G can be observed on other counterparts (FIG. 65).

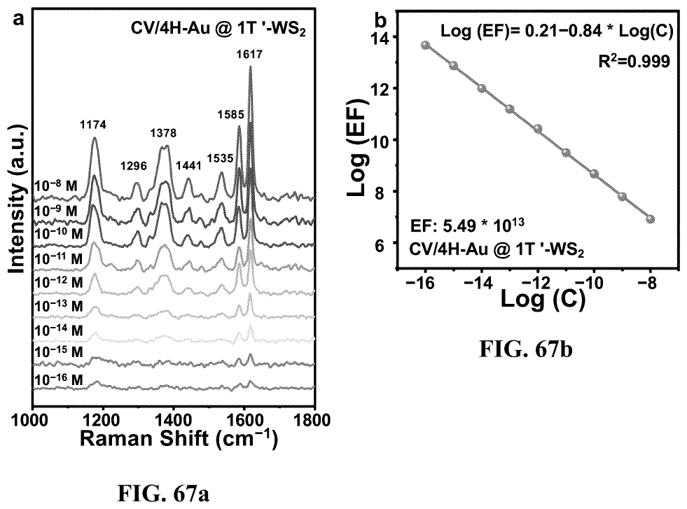

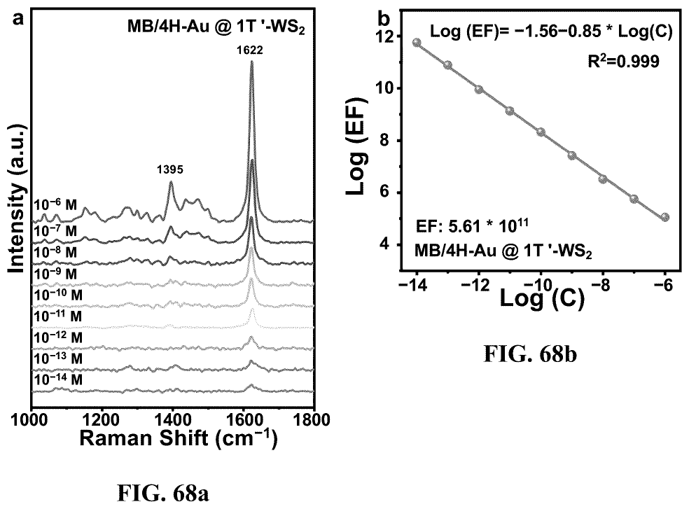

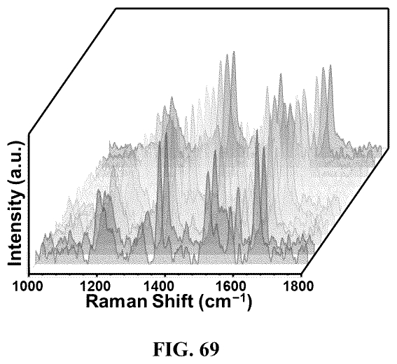

To investigate the sensitivity and LOD of a single 4H—Au@1T′-WS₂, a set of R6G solutions with various concentrations from 10⁻⁹ M (nM) to 10⁻¹⁸ M (aM) were prepared. The enhanced Raman signals of R6G at 1180, 1306, 1360, 1504, 1572, and 1650 cm⁻¹ can be discerned with gradually decreased concentrations from 10⁻¹² M (pM) to 10⁻¹⁸ M (aM) (FIG. 5f). The fingerprint Raman bands were still detectable at an ultralow LOD of 10⁻¹⁸ M, exhibiting a distinguishable Raman intensity of 126 at 1360 cm⁻¹. The corresponding EF was calculated to be 1.69×10¹⁵, taking the bulk R6G analyte as the reference (FIG. 66). It is noteworthy that this attomole-level detection of R6G molecules enables the 4H—Au@1T′-WS₂ as an ultrasensitive platform for SERS, displaying the best SERS performance compared with all the reported TMD-based materials for SERS detection (Table 1). In addition, the ultrasensitive SERS effect on a single 4H—Au@1T′-WS₂ is effective on a broad range of dyes beyond R6G, such as crystal violet (CV) and methylene blue (MB). As illustrated in FIG. 67 and FIG. 68, when approaching ultralow LOD of 10⁻¹⁶ M and 10⁻¹⁴ M, the characteristic fingerprint Raman peaks of CV and MB are still distinguishable from the noise, and the corresponding EF for CV and MB can be calculated as 5.49×10¹³ and 5.61×10¹¹, respectively. Traditional metallic nanostructures and even semiconductor SERS substrates suffer from the photocatalytic degradation of the dye molecules. However, as depicted in FIG. 69, there is no obvious decrease in the analyte Raman intensity on 4H—Au@1T′-WS₂ during the photostability test, indicating that 4H—Au@1T′-WS₂ can greatly reduce the unwanted degradation of the analyte under illumination. The superior stability can be ascribed to the large charge transfer between dye molecules and 1T′-WS₂, which promotes the charge relaxation from the excitation states of analyte.

TABLE 1
Summary of the noble metal-2D material hybrid structures for SERS sensing

| | Probe | | | Enhanced |
|---|---|---|---|---|
| Materials | molecule | Excitation | LOD/EF | mechanism |
| 4H Au@1T′ WS₂ | R6G | 532 nm | 10⁻¹⁸ M/ | EM + CM |
| | | | 1.69 × 10¹⁵ | |
| 4H Au@1T′ WS₂ | CV | 532 nm | 10⁻¹⁶ M/ | EM + CM |
| | | | 5.49 × 10¹³ | |
| 4H Au@1T′ WS₂ | MB | 532 nm | 10⁻¹⁴ M/ | EM + CM |
| | | | 5.61 × 10¹¹ | |
| AuNPs-1T′ MoTe₂ | R6G | 532 nm | 4 × 10⁻¹⁷ | EM + CM |
| | | | M/N.A. | |
| Ag NW-Ag NP-MoS₂ | R6G | 633 nm | 10⁻¹¹ M/10⁶ | EM + CM |
| 1T-2H MoS₂/Au | R6G | 514 nm | 10⁻¹⁰ M/ | EM + CM |
| | | | 8.1 × 10⁶ | |
| Ag NP/MoS₂/Au NP | R6G | 532 nm | 0.74 × 10⁻¹⁴ M/ | EM + CM |
| | | | 4.98 × 10⁹ | |
| Au NPs/MoS₂/graphene | R6G | 532 nm | 5 × 10⁻¹⁰ M | EM + CM |
| h-BN/Au NPs | R6G | 532 nm | 10⁻⁹ M | EM + CM |
| Graphene/Au | R6G | 532 nm | 10⁻¹⁴ M | EM + CM |
| nanopyramid | | | | |

The large enhancement of the Raman signal based on the 4H—Au@1T′-WS₂ may result from both semi-metallic 1T′-WS₂ and plasmonic 4H—Au. First, as a typical 2D material, 1T′-WS₂ can realize excellent surface adsorption of dye molecules due to its low-symmetry 1T′ phase as well as the π-π interaction at the interface of the analyte and 1T′-WS₂. The zig-zag chains of 1T′-WS₂ grown on the concave and convex surface of the 4H—Au may provide more sites to adsorb dye molecules. Second, when the layer number of 2D materials decreases, the overall SERS performance may increase. Impressively, the 1T′-WS₂ on 4H—Au possesses a single-layer nature, which exhibits the best intrinsic SERS performance caused by the charge transfer mechanism. Moreover, the single-layer 1T′-WS₂ shell keeps 4H—Au from aggregation to maximally extend the electromagnetic field, similar to the well-defined SHINERS nanostructures. Third, the intense local electromagnetic field generated by 4H—Au contributes to the enhancement of the Raman signal. Fourth, the covalent Au—S contact between the 1T′-WS₂ shell and 4H—Au core may act as a bridge to synergistically facilitate the charge transfer. In short, the ultrasensitive SERS effect of the 4H—Au@1T′-WS₂ is attributed to the enriched molecular adsorption, efficient charge transfer of 1T′-WS₂ monolayers, strong electromagnetic field of 4H—Au as well as the synergistic effect of 1T′-WS₂ and 4H—Au.

SERS Detection of SARS-CoV-2 S Protein.

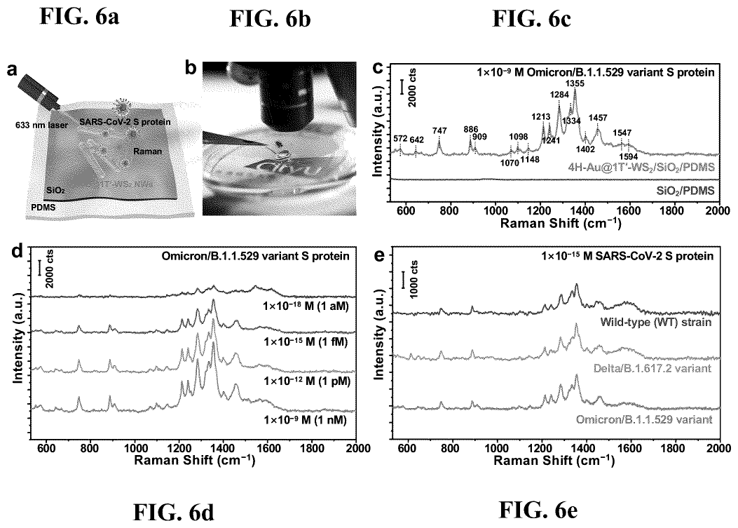

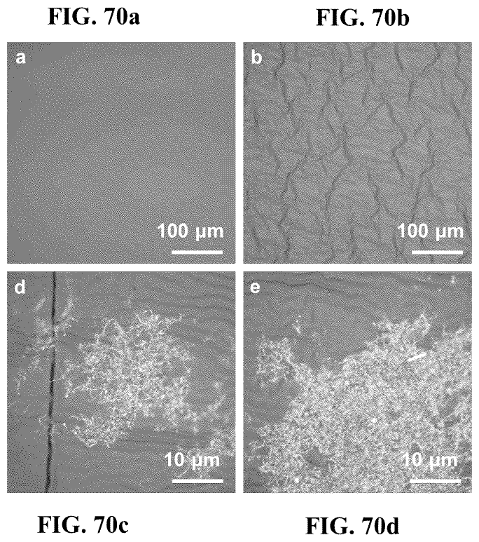

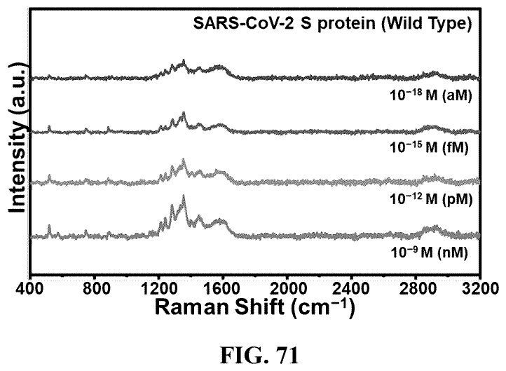

To date, the whole world still suffers from the COVID-19 pandemic. As a more infectious subtype of SARS-CoV-2, Omicron (B.1.1.529) variant rapidly became the predominant SARS-CoV-2 strain worldwide in a short time. As known, accompanying the excreta of COVID-19 patients, Omicron variant in the saliva, stool, urine, and sputum of COVID-19 patients may enter the wastewater systems to contaminate the water environment, which can remain infectious for up to 17-31 days. Therefore, it is necessary to develop an ultrasensitive and cost-effective method to detect and early warn the Omicron variant in the environmental water to prevent the spread of pandemics. SERS is a non-destructive, rapid, and high-sensitive detection technique that can detect single proteins, displaying great potential to detect the coronavirus. However, the Raman signals of other proteins or biomolecules in the Omicron variant contaminated water may overwhelm the signal of Omicron variant, resulting in a poor signal-to-noise ratio⁶⁸. Hence, it is highly desirable to rationally design and synthesize advanced materials for ultrasensitive SERS detection to accurately capture and distinguish the Raman signal of Omicron variant from other SARS-CoV-2 variants. Therefore, a flexible and transparent SERS tape based on 4H—Au@ 1T′-WS₂ was fabricated to realize ultrasensitive SERS detection for daily life applications (FIG. 6a). We first deposited a 50 nm-thick layer of SiO₂ on a PDMS film through magnetron sputtering. Then 10 μL of 4H—Au@1T′-WS₂ solution was dropped on the surface of the tape. After drying, the flexible 4H—Au@ 1T′-WS₂/SiO₂/PDMS SERS tape was ready for the detection of the Omicron variant (FIG. 70d). As known, although the SARS-CoV-2 virus with a diameter of about 100 nm is larger than the conventional analyte for SERS detection, the spike (S) glycoprotein with a size of several nanometers covered on SARS-CoV-2 can be detected by SERS⁶⁸⁻⁷⁰. As illustrated in FIG. 6b, we used the diluted SARS-CoV-2 S protein (Omicron/B.1.1.529 variant) in phosphate-buffered saline (PBS) to simulate the Omicron variant in the contaminated environmental water. After immersing in the Omicron variant S protein solution with various concentrations from 10⁻⁹ M (nM) to 10⁻¹⁸ M (aM), the 4H—Au@1T′-WS₂/SiO₂/PDMS tape was used to detect the Raman signals under an excitation wavelength of 633 nm. Notably, sharp and distinct Raman signals of Omicron variant S protein can be observed on the 4H—Au@1T′-WS₂, whereas no obvious Raman signals can be collected on the bare SiO₂ (FIG. 6c) As demonstrated in Table 2, the Raman peaks detected on the 4H—Au@ 1T′-WS₂ are in good agreement with the previously reported characterized Raman bands of SARS-CoV-2 S protein. Moreover, we further explored the LOD for SARS-CoV-2 S protein based on 4H—Au@ 1T′-WS₂. Impressively, the fingerprint Raman bands of Omicron variant S protein are still detectable at an ultralow LOD of 10⁻¹⁸ M (aM) by adsorbing on the 1T′-WS₂ monolayer covered on 4H—Au (FIG. 6d). Similarly, the characteristic Raman signals of SARS-CoV-2 S protein (Wild Type) can also be detected in the concentration range from 10⁻⁹ M (nM) to 10⁻¹⁸ M (aM) (FIG. 71). Therefore, the 4H—Au@1T′-WS₂ with ultrahigh sensitivity exhibits great possibility to identify the different subtypes of SARS-CoV-2. As shown in FIG. 6e, we compared the Raman spectra of Omicron/B.1.1.529 variant and Wild Type S protein solution with a fixed concentration of 10⁻¹⁵ M (fM). And slight difference in the peak position, intensity and morphology can be observed between Omicron/B.1.1.529 variant and Wild Type. The ultrasensitive SERS performance endows the 4H—Au@1T′-WS₂ with an attomole-level detection of SARS-CoV-2 S protein, which is beneficial to achieving real-time monitoring and early warning of SARS-CoV-2 variants in the future.

TABLE 2
Summary of Raman peaks (cm⁻¹) and their assignment of the SARS-CoV-2 S protein.

| Peaks of | | Peaks of | |
|---|---|---|---|
| Omicron variant | | SARS-CoV-2 | |
| S protein/cm⁻¹ | Assignments | S protein/cm⁻¹ | Assignments |
| (Experiment) | (Experiment) | (Literature) | (Literature) |
| 518 | ν(S—S) | 523.3 | ν(S—S) |
| 573 | Tryptophan, ν(C—N) in indole | 567 | Amide V |
| | ring | | |
| 642 | Tyrosine, ρ_{τ}(C—C) | 645 | Tyrosine, ρ_{τ}(C—C) |
| 747 | Tryptophan, ν(Φ) | 758, 778 | Tryptophan, Phenylalanine, ν(Φ, |
| | | | indole ring) |
| 886 | Tyrosine & Tryptophan, | 880, 874 | Tryptophan, W17 [δ(CH) _{ΦPh} & |
| | ν(N—H) | | δ(N—H)] |
| 909 | Skeleton, ν(C—C) | 906 | Skeleton, ν(C—C, α-Helix) |
| 1098 | Phenylalanine & Tryptophan, | 1034 | Phenylalanine, ρ_{ipb}(C—H) |
| | δ & ν(C═C, —CH) in | | |
| | aromatic ring | | |
| 1148 | ν(C—N) | 1155 | ν(C—N) |
| 1213, 1241 | Phenylalanine & Tryptophan, | 1215-1285 | Phenylalanine & Tryptophan, |
| | ν(C—C₆H₅) | | ν(C—C₆H₅) |
| 1284 | Skeleton, ν(C—H) &ν(NH) | 1296 | Amide III (α-Helix) |
| 1334 | ν(COO^{—}) | 1326 | ν(COO^{—}) |
| 1355, 1402 | Phenylalanine & Tryptophan, | 1365 | Tryptophan, W7[ν(N₁—C₈)] |
| | ν(C—C), ν(C—N) | | |
| 1457 | Amino acid, ν(—CH2) | 1445 | Amino acid, ν(—CH₂) |
| 1513 | ρ_{τ,}(C—H) & ν(C═N) & ν(C═C) | 1515, 1509- | Amide II |
| | | 1522, 1529 | |
| 1594 | ν(Φ) or ν(indole ring) | 1591 | Tyrosine & Phenylalanine, ν(Φ) |

### INDUSTRIAL APPLICABILITY

The present invention demonstrates a low-temperature and rapid wet-chemical synthetic method to directly synthesize a series of 1T′-TMD monolayers, including 1T′-WS₂, WSe₂, MoS₂, and MoSe₂ on 4H—Au NWs. The as-prepared 1T′-TMD monolayers on 4H—Au exhibit the highest phase purity in comparison with the reported TMDs prepared by the wet-chemical method such that the cost-effective techniques of the invention may be used to create commercial-scale products. Importantly, the strong covalent Au—S/Se interfacial interaction between 1T′-TMD and 4H—Au can purify and stabilize the 1T′-TMD monolayers. In one application, a single 4H—Au@1T′-WS₂ exhibits the ultrasensitive SERS performance. Specifically, the LOD of dye R6G coated on a single 4H—Au@1T′-WS₂ can achieve attomolar levels (1018 M), and the Raman EF can reach 1.69×10¹⁵. Importantly, we fabricated the 4H—Au@1T′-WS₂/SiO₂/PDMS SERS tape to detect the Raman signals of SARS-CoV-2 S protein (Omicron/B.1.1.529 variant). The LOD of Omicron variant S protein is as low as 10⁻¹⁸ M, which is conducive to realizing real-time monitoring and early warning of COVID-19 based on SERS technology. The ultrasensitive SERS performance of the 4H—Au@1T′-WS₂ can be ascribed to the enriched molecular adsorption, efficient charge transfer of 1T′-WS₂, the strong electromagnetic field of 4H—Au as well as the synergistic effect between 4H—Au and 1T′-WS₂. The invention demonstrates techniques to prepare high-quality and high-purity metastable TMDs via metallic substrate engineering, which may be applied to the synthesis of metastable TMDs by various synthetic methods on novel metallic substrates in for other systems. The present invention may be applied in various SERS detection applications, including the inspection of virus or bacteria contamination, food safety, environmental pollutants, and drugs.

The embodiments were chosen and described in order to best explain the principles of the invention and its practical application, thereby enabling others skilled in the art to understand the invention for various embodiments and with various modifications that are suited to the particular use contemplated.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. The term “substantially coplanar” can refer to two surfaces within micrometers of lying along a same plane, such as within 40 μm, within 30 μm, within 20 μm, within 10 μm, or within 1 μm of lying along the same plane.

As used herein, the singular terms “a,” “an,” and “the” may include plural referents unless the context clearly dictates otherwise. In the description of some embodiments, a component provided “on” or “over” another component can encompass cases where the former component is directly on (e.g., in physical contact with) the latter component, as well as cases where one or more intervening components are located between the former component and the latter component.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. The specification and the drawings are to be regarded as illustrative rather than restrictive. Modifications may be made to adapt a particular situation, material, composition of matter, method, or process to the objective, spirit, and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

1. A method of forming a 1T′-phase transition metal dichalcogenide monolayer comprising:
mixing a transition metal precursor and a first solvent to form a first mixture;
mixing a non-oxygen chalcogen or non-oxygen chalcogen precursor and a second solvent to form a second mixture;
rapidly injecting the first mixture into the second mixture at a temperature between approximately 250 and 350° C. to form a third mixture;
recovering 1T′-transition metal dichalcogenide monolayers from the third mixture.

2. The method of claim 1, wherein the first solvent is oleylamine.

3. The method of claim 1, wherein the second mixture further comprises octadecylamine, oleylamine, and octadecene.

4. The method of claim 1, wherein a transition metal of the transition metal precursor is selected from one or more of tungsten or molybdenum.

5. The method of claim 1, wherein the transition metal precursor is selected from one or more of ammonium tungsten oxide or ammonium molybdate, tungsten chloride or molybdenum chloride.

6. The method of claim 1, wherein the non-oxygen chalcogen is selected from one or more of sulfur, selenium, or tellurium.

7. The method of claim 1, wherein the 1T′-transition metal dichalcogenide monolayers are selected from MoS₂, WS₂, MoSe₂, WSe₂, or MoTe₂ monolayers.

8. The method of claim 1, wherein the 1T′-transition metal dichalcogenide monolayers are formed on a substrate.

9. The method of claim 8, wherein the substrate is metal substrate.

10. The method of claim 9, wherein the metal substrate is gold nanoparticles.

11. The method of claim 10, wherein the gold nanoparticles are gold nanowires.

12. The method of claim 11, wherein the gold nanowires are 4H phase gold nanowires.

13. The method of claim 1, wherein the recovering is performed by centrifugation.

14. The method of claim 1, further comprising depositing the 1T′-transition metal dichalcogenide monolayers on a polymer substrate having a hard transparent coating formed thereon to create a substrate for surface-enhanced Raman spectroscopy (SERS).
